(19) United States
(12) Patent Application Publication
(10) Pub. No.: US 2021/0268552 A1
(43) Pub. Date: Sep. 2, 2021

(54) CLEANING DEVICE ASSEMBLY

(71) Applicant: Positec Power Tools (Suzhou) Co., Ltd., Jiangsu (CN)

(72) Inventors: Xiahong ZHA, Jiangsu (CN); Fengli ZHAO, Jiangsu (CN); Yong QIAO, Jiangsu (CN)

(21) Appl. No.: 17/256,160

(22) PCT Filed: Jun. 28, 2019
(86) PCT No.: PCT/CN2019/093622

§ 371 Date: Dec. 24, 2020

(30) Foreign Application Priority Data
Jun. 29, 2018 (CN) 201810715824.5
Sep. 11, 2018 (CN) 201811054477.2

(51) Int. Cl. B08B 3/02; B05B 9/08

(52) U.S. Cl. CPC B08B 3/028; B08B 2203/027; B08B 2203/0223; B05B 9/0861

(57) ABSTRACT

The present invention relates to a cleaning device assembly, including a spray gun assembly, where the spray gun assembly includes a spray gun housing, a spray gun liquid inlet for a fluid to enter and a spray gun liquid outlet for a fluid to be sprayed are provided in the spray gun housing, and the spray gun housing further includes a handle for holding; a power assembly, where the power assembly and the spray gun assembly are separately disposed, the power assembly includes a pump and a motor configured to drive the pump to work, and the power assembly further includes a fluid inlet for a fluid to enter and a fluid outlet for a pressurized fluid to be sprayed; a power supply assembly, supplying energy to the motor; and a connecting path, connected between the spray gun assembly and the power assembly, where the connecting path includes a liquid outlet pipeline connected between the spray gun liquid inlet and the fluid outlet, where the power supply assembly is independent of the power assembly, and the power supply assembly is disposed on the spray gun assembly.

### CROSS REFERENCE TO RELATED REFERENCE

This application is a National Stage Application of International Application No. PCT/CN2019/093622, filed on Jun. 28, 2019, which claims priority to Chinese Patent Application 201810715824.5, filed on Jun. 29, 2018, and entitled “CLEANING DEVICE” and Chinese Patent Application 201811054477.2, filed on Sep. 11, 2018, and entitled “CLEANING DEVICE AND MAIN UNIT ASSEMBLY APPLIED TO CLEANING DEVICE”, which is incorporated herein by reference in its entirety.

### BACKGROUND

### Technical Field

The present invention relates to the field of cleaning technology, and in particular, to a cleaning device assembly.

### Related Art

A cleaning device has advantages such as high working efficiency and high safety and is adequate for cleaning of large-area objects such as vehicles, doors and windows, and floor-to-ceiling glass. The cleaning device is portable and conveniently usable and also reduces the workload of manual cleaning, bringing great convenience to people's life.

An existing cleaning device integrates a pump, a motor, a battery, and a spray gun structure for convenient use. To prolong the operating time of the cleaning device, the capacity of a power supply battery pack is increased, for example, dual battery packs are used for power supply. It is convenient to use such an integrated cleaning device. However, a user usually holds the cleaning device for operation. Therefore, it is somewhat physically demanding for an operator to hold the cleaning device, resulting in poor human-machine interaction.

Another common commercially available floor-type cleaning device includes a main unit for accommodating a functional part, a spray gun for spraying a fluid pressurized by the functional part, and a water pipe for connecting the spray gun to the main unit. The cleaning device has a lightweight spray gun that is easier to hold and can provide more adequate dirt cleaning capability. However, the main unit of the cleaning device is large and heavy, and it requires much effort to carry the cleaning device to perform cleaning in different working scenarios.

### SUMMARY

Based on this, to resolve the foregoing technical problems, it is necessary to provide a cleaning device in which a spray gun is not heavy and a power assembly that is provided separately from the spray gun is light in weight but not large in size, to balance the weight of the spray gun with that of the power assembly and improve the dirt cleaning capability, to meet a cleaning requirement of a user and provide adequate human-machine interaction.

To achieve the above objectives, the present invention adopts the following technical solution: A cleaning device assembly is provided, including: a spray gun assembly, where the spray gun assembly includes a spray gun housing, a spray gun liquid inlet for a fluid to enter and a spray gun liquid outlet for a fluid to be sprayed are provided in the spray gun housing, and the spray gun housing further includes a handle for holding; a power assembly, where the power assembly and the spray gun assembly are separately disposed, the power assembly includes a pump and a motor configured to drive the pump to work, and the power assembly further includes a fluid inlet for a fluid to enter and a fluid outlet for a pressurized fluid to be sprayed; a power supply assembly, supplying energy to the motor; and a connecting path, connected between the spray gun assembly and the power assembly, where the connecting path includes a liquid outlet pipeline connected between the spray gun liquid inlet and the fluid outlet, where the power supply assembly is independent of the power assembly, and the power supply assembly is disposed on the spray gun assembly.

In one of the implementations, the connecting path further includes a power supply line for electrically connecting the power supply assembly and the motor, and both the power supply line and the liquid outlet pipeline are connected between the spray gun housing and the power assembly.

In one of the implementations, the spray gun assembly includes a first electrical connection port, the power assembly is provided with a second electrical connection port, and the power supply line is connected between the first electrical connection port and the second electrical connection port, to transmit electric energy connected to the spray gun assembly to the power assembly; and the liquid outlet pipeline is communicatively connected between the fluid outlet and the spray gun liquid inlet.

In one of the implementations, the liquid outlet pipeline and the fluid outlet are connected in a sealed manner, and the liquid outlet pipeline and the spray gun liquid inlet are connected in a sealed manner.

In one of the implementations, the power supply line and the liquid outlet pipeline are configured as a water and electricity integrated pipe, so that both the power supply line and the liquid outlet pipeline are connected between the fluid outlet and the spray gun liquid inlet, to implement both water supply and power supply.

In one of the implementations, the power supply assembly is a rechargeable battery pack, the battery pack is detachably assembled on the spray gun housing, and the spray gun assembly and the battery pack form a spray gun.

In one of the implementations, the battery pack is detachably mounted at one end, away from the spray gun liquid outlet, of the handle.

In one of the implementations, it is defined that there is a holding support point when a user holds the handle, a center of gravity G1 of the spray gun assembly is located on a front side of the holding support point, a center of gravity G2 of the spray gun is located on a rear side of the holding support point, and an axial distance L1 between the center of gravity G1 of the spray gun assembly and the holding support point is greater than an axial distance L2 between the center of gravity G2 of the spray gun and the holding support point.

In one of the implementations, the spray gun assembly includes a spray bar for spraying a fluid, the spray bar is detachably connected to the spray gun housing, there are two battery packs, a nominal output voltage of each battery pack is between 18 V and 42.4 V, and a capacity of the each battery pack is between 2 Ah and 8 Ah, so that a product of a weight of the spray gun and the axial distance L2 is less than a product of a weight of the spray gun assembly and the axial distance L1.

In one of the implementations, the spray gun assembly includes a spray bar for spraying a fluid, the spray bar is detachably connected to the spray gun housing, there is one battery pack, a nominal output voltage of the battery pack is between 18 V and 80 V, and a capacity of the battery pack is between 2 Ah and 12 Ah, so that a product of a weight of the spray gun and the axial distance L2 is less than a product of a weight of the spray gun assembly and the axial distance L1.

In one of the implementations, a weight of the each battery pack is set between 300 g and 1600 g, and a ratio of the weight of the spray gun to the weight of the spray gun assembly is between 2 and 3, so that a ratio of the axial distance L2 to the axial distance L1 is less than ⅓.

In one of the implementations, the spray gun housing further includes a main portion disposed at an angle from the handle, an extending direction of the main portion is basically consistent with a spraying direction of the fluid, the main portion matches the handle to form an enclosed space, and in a longitudinal direction, the battery pack is located in the enclosed space.

In one of the implementations, a ratio of a weight of the power assembly to a total weight of the spray gun and the power assembly is not greater than 50%.

In one of the implementations, the motor includes a motor shaft for driving the pump to pressurize the fluid, and in a direction perpendicular to an extending direction of the motor shaft, a maximum cross-sectional area of the power assembly is not greater than 35000 mm2.

In one of the implementations, the power assembly further includes a transmission mechanism disposed between the motor and the pump, the transmission mechanism includes a speed reduction mechanism for reducing a rotational speed of the motor and transmitting the reduced rotational speed to the pump, and the motor, the transmission mechanism and the pump are sequentially arranged in an extending direction of a motor shaft.

In one of the implementations, the motor includes a motor accommodating body that circumferentially surrounds at least a part of a periphery of the motor, the power assembly includes a main housing surrounding a periphery of the power assembly, a cooling channel is formed between the main housing and the motor accommodating body, and the cooling channel is in fluid communication with the fluid inlet.

To achieve the above objectives, the present invention adopts the following technical solution: a cleaning device is provided, including a spray gun assembly, where the spray gun assembly includes a spray gun housing, a spray gun liquid inlet for a fluid to enter and a spray gun liquid outlet for a fluid to be sprayed are provided in the spray gun housing, and the spray gun housing further includes a handle for holding; a power assembly, where the power assembly and the spray gun assembly are separately disposed, the power assembly includes a pump and a motor connected to the pump and configured to drive the pump to work, the power assembly further includes a fluid inlet for a fluid to enter and a fluid outlet for a fluid to be sprayed, and the fluid is pressurized inside the pump and is then discharged from the fluid outlet; a battery pack mounting portion, configured to allow a battery pack to be detachably connected; and a connecting path, connected between the spray gun assembly and the power assembly, where the connecting path includes a liquid outlet pipeline connected between the spray gun liquid inlet and the fluid outlet; and the battery pack mounting portion is disposed on the spray gun housing, so that the battery pack, the motor disposed on the power assembly, and the pump are distributed.

In one of the implementations, the spray gun assembly and the battery pack form a spray gun, and a ratio of a weight of the power assembly to a total weight of the spray gun and the power assembly is not greater than 50%.

In one of the implementations, the connecting path further includes a power supply line for electrically connecting the battery pack and the motor, and both the power supply line and the liquid outlet pipeline are connected between the spray gun housing and the power assembly.

In one of the implementations, the spray gun assembly includes a first electrical connection port, the power assembly is provided with a second electrical connection port, and the power supply line is connected between the first electrical connection port and the second electrical connection port, to transmit electric energy connected to the spray gun assembly to the power assembly; and

the liquid outlet pipeline is communicatively connected between the fluid outlet and the spray gun liquid inlet.

In one of the implementations, the power supply line and the liquid outlet pipeline are configured as a water and electricity integrated pipe, so that both the power supply line and the liquid outlet pipeline are connected between the fluid outlet and the spray gun liquid inlet, to implement both water supply and power supply.

The present invention further provides a cleaning device assembly that does not need to be carried by a user during use, can move freely in a plurality of working scenarios, and is conveniently usable.

To achieve the above objectives, the present invention adopts the following technical solution: a cleaning device assembly is provided, including: a spray gun assembly, including a spray gun housing, where a spray gun liquid inlet for a fluid to enter and a spray gun liquid outlet for a fluid to be sprayed are provided in the spray gun housing; a battery pack, attached to the spray gun housing; and a power assembly, disposed separately from the spray gun assembly, where the power assembly includes a main housing, a functional part accommodated in the main housing, a fluid inlet for drawing a fluid, and a fluid outlet for discharging the drawn fluid, and the functional part includes a pump for pressurizing the fluid and a motor configured to drive the pump to work; and the cleaning device assembly further includes a connecting path disposed between the spray gun assembly and the power assembly, and the connecting path is at least capable of transmitting a fluid discharged by the fluid outlet to the spray gun liquid inlet; and the main housing is provided with a joint connected to the connecting path and a support surface that is pulled by the joint and is movable on the ground.

In one of the implementations, the main housing includes a whole body portion surrounding at least a part of an outer side of the functional part and a transition section mated with the connecting path, and the transition section narrows from the whole body portion to the connecting path.

In one of the implementations, the connecting path has an axial line, and a maximum distance between the axial line of the connecting path and an outermost edge of an upper end face of the transition section is not greater than five times an outer diameter of the connecting path.

In one of the implementations, a ratio of a cross-sectional area of the connecting path in a radial direction to a cross-sectional area of a maximum profile of an upper end face of the transition section in a radial direction is between 1:1 and 1:70.

In one of the implementations, a surface that is orthogonal to an extending direction of a motor shaft is defined as an orthogonal surface, and a maximum radial distance between a projection profile of the outermost edge of the upper end face of the transition section on the orthogonal surface and a projection profile of the connecting path on the orthogonal surface is not greater than 55 mm.

In one of the implementations, the motor includes a motor shaft, a surface that is orthogonal to an extending direction of the motor shaft is defined as an orthogonal surface, and an angle between an outermost profile line of the transition section and the orthogonal surface is greater than or equal to 30 degrees and less than 90 degrees.

In one of the implementations, a connection part between the whole body portion and the transition section is in a curved transition connection.

In one of the implementations, the transition section includes a neck portion extending in a vertical direction and a shoulder portion connected between the neck portion and the whole body portion, the fluid outlet is provided at a free end of the neck portion, and an outer wall surface of the shoulder portion is curved.

In one of the implementations, when the power assembly is horizontally placed on the ground, both the fluid inlet and the fluid outlet are suspended and move on the ground by using the whole body portion as a support.

In one of the implementations, the fluid inlet and the fluid outlet are provided facing away from each other at two ends in an axial direction.

In one of the implementations, an axial line of the fluid inlet is parallel to or basically consistent with an axial line of the fluid outlet.

In one of the implementations, a center of gravity of the power assembly is located on an extension line of an axial line X1 of the connecting path or a distance offset to left or to right from the axial line X1 is within four times an outer diameter of the connecting path.

In one of the implementations, the whole body portion is further provided with a movement structure, the movement structure includes at least two convex ribs protruding outward, the convex rib extends by a preset length in a vertical direction, and the power assembly is movable by using the convex rib as a sliding rail.

In one of the implementations, the battery pack is detachably disposed on the spray gun housing, and the battery pack and the functional part are distributed.

In one of the implementations, the spray gun assembly and the battery pack form a spray gun, and a ratio of a weight of the power assembly to a total weight of the spray gun and the power assembly is not greater than 50%.

In one of the implementations, the spray gun assembly and the battery pack form a spray gun, there are two battery packs, a nominal output voltage of each battery pack is between 18 V and 42.4 V, and a capacity of the each battery pack is between 2 Ah and 8 Ah, so that a weight of the spray gun is between 2 kg and 4.5 kg, and a weight of the power assembly is not greater than the weight of the spray gun.

In one of the implementations, the spray gun assembly and the battery pack form a spray gun, there is one battery pack, a nominal output voltage of the battery pack is between 18 V and 80 V, and a capacity of the battery pack is between 2 Ah and 12 Ah, so that a weight of the spray gun is between 2 kg and 4.5 kg, and a weight of the power assembly is not greater than the weight of the spray gun.

In one of the implementations, the power assembly further includes a transmission mechanism disposed between the motor and the pump, the transmission mechanism includes a speed reduction mechanism for reducing a rotational speed of the motor and transmitting the reduced rotational speed to the pump, and the motor, the transmission mechanism and the pump are sequentially arranged in an extending direction of a motor shaft.

In one of the implementations, in a direction perpendicular to an extending direction of the motor shaft, a maximum cross-sectional area of the power assembly is not greater than 35000 mm2.

In one of the implementations, the cleaning device assembly further includes a support structure for supporting the power assembly that is placed vertically, and the support structure is located at a lower end of the whole body portion in an axial direction and surrounds a periphery of the fluid inlet.

In one of the implementations, when the power assembly is vertically supported on the ground, a gap is provided between a bottommost end of the fluid inlet and the ground.

In one of the implementations, the connecting path includes a liquid outlet pipeline connected between the fluid outlet and the spray gun liquid inlet and a power supply line for electrically connecting the battery pack and the motor, the liquid outlet pipeline is capable of transmitting a fluid pressurized by the pump to the spray gun assembly, and both the power supply line and the liquid outlet pipeline are connected between the spray gun housing and the power assembly.

In one of the implementations, the cleaning device assembly further includes a liquid inlet path mated with the fluid inlet, to introduce an external fluid into the power assembly, and the liquid inlet path, the power assembly and the liquid outlet pipeline form a connecting member connected to the spray gun assembly.

To achieve the above objectives, the present invention adopts the following technical solution: a cleaning device assembly is provided, including: a spray gun assembly, including a spray gun housing, where a spray gun liquid inlet for a fluid to enter and a spray gun liquid outlet for the fluid entering from the spray gun liquid inlet to be sprayed are provided in the spray gun housing; a power supply assembly, supplying energy; a power assembly, disposed separately from the spray gun assembly, where the power assembly includes a fluid inlet for a fluid to enter and a fluid outlet for a fluid to be sprayed, the power assembly further includes a main housing and a functional part accommodated in the main housing, and the functional part includes a pump for pressurizing the fluid and a motor configured to drive the pump to work; and a connecting path, provided between the spray gun assembly and the power assembly, where the connecting path is at least capable of transmitting the fluid discharged by the fluid outlet to the spray gun liquid inlet, where the main housing is provided with a joint that is connected to the connecting path and is capable of pulling the power assembly to move, the main housing extends in three orthogonal spatial directions (x, y, z), that is, in a direction of a height axis of the main housing, a direction of a width axis of the main housing, and a direction of a depth axis of the main housing, the main housing has a height, a width, and a depth, the height is greater than the width, the height is greater than the depth, and a pulling direction of the joint is consistent with an extending direction of the height axis.

In one of the implementations, when the power assembly is horizontally placed on the ground, as observed from above, a center of gravity of the power assembly is located on an extension line of an axial line X1 of the connecting path or a distance offset to left or to right from the axial line X1 is within four times an outer diameter of the connecting path.

In one of the implementations, the main housing includes a whole body portion surrounding at least a part of an outer side of the functional part and a transition section mated with the connecting path, and the transition section narrows from the whole body portion to the connecting path.

In one of the implementations, the connecting path has an axial line, and a maximum distance between the axial line of the connecting path and an outermost edge of an upper end face of the transition section is not greater than five times an outer diameter of the connecting path.

In one of the implementations, a ratio of a cross-sectional area of the connecting path in a radial direction to a cross-sectional area of a maximum profile of an upper end face of the transition section in a radial direction is between 1:1 and 1:70.

In one of the implementations, a surface that is orthogonal to an extending direction of a motor shaft is defined as an orthogonal surface, and a maximum radial distance between a projection profile of the outermost edge of the upper end face of the transition section on the orthogonal surface and a projection profile of the connecting path on the orthogonal surface is not greater than 55 mm.

In one of the implementations, the motor includes a motor shaft, a surface that is orthogonal to an extending direction of the motor shaft is defined as an orthogonal surface, and an angle between an outermost profile line of the transition section and the orthogonal surface is greater than or equal to 30 degrees and less than 90 degrees.

In one of the implementations, the transition section includes a neck portion extending in a vertical direction and a shoulder portion connected between the neck portion and the whole body portion, the fluid outlet is provided at a free end of the neck portion, and the shoulder portion narrows from the whole body portion to the neck portion.

In one of the implementations, the power supply assembly is a battery pack, the battery pack is detachably disposed on the spray gun housing, and the battery pack and the functional part are distributed.

In one of the implementations, the spray gun assembly and the battery pack form a spray gun, and a ratio of a weight of the power assembly to a total weight of the spray gun and the power assembly is not greater than 50%.

To achieve the above objectives, the present invention further adopts the following technical solution: a cleaning device assembly is provided, including: a spray gun assembly, including a spray gun housing, where a spray gun liquid inlet for a fluid to enter and a spray gun liquid outlet for the fluid entering from the spray gun liquid inlet to be sprayed are provided in the spray gun housing; a connecting member, configured to transmit an external fluid to the spray gun liquid inlet, where an end of the connecting member is attached to the spray gun assembly; and a power supply assembly, supplying energy, where the connecting member includes a fluid pressurization path for pressurizing a drawn fluid and a connecting path at least capable of transmitting the pressurized fluid to the spray gun assembly, the fluid pressurization path includes a fluid inlet for a fluid to be drawn and a fluid outlet for a fluid to be sprayed, and the fluid pressurization path is configured as a power assembly for providing a power source, to pressurize the fluid entering from the fluid inlet; and

a maximum cross-sectional area of the connecting member in a direction perpendicular to an extending direction of a length of the connecting path is not greater than 35,000 mm2.

In one of the implementations, a ratio of a maximum cross-sectional area of the fluid pressurization path in a direction perpendicular to the extending direction of the length of the connecting path to a maximum cross-sectional area of the connecting path in a direction perpendicular to the extending direction of the length of the connecting path is not greater than 445.

In one of the implementations, the connecting member further includes a liquid inlet path mated with the fluid inlet, and the liquid inlet path may be configured as a liquid inlet pipe for directly drawing an external water source or a container for providing a water source.

In one of the implementations, the liquid inlet path and the fluid pressurization path are detachably connected, and the fluid pressurization path and the connecting path are fixedly connected or detachably connected.

In one of the implementations, a maximum cross-sectional area of the connecting member is formed on the fluid pressurization path in a direction perpendicular to an extending direction of a length of the connecting path, the fluid pressurization path includes a main housing, a pump accommodated in the main housing, and a motor configured to drive the pump to work, the power supply assembly is a rechargeable battery pack, the battery pack is detachably assembled on the spray gun housing, and the battery pack and the functional part are distributed.

In one of the implementations, the connecting path includes a liquid outlet pipeline connected between the fluid outlet and the spray gun liquid inlet and a power supply line for electrically connecting the battery pack and the motor, the liquid outlet pipeline transmits a pressurized fluid to the spray gun assembly, and both the power supply line and the liquid outlet pipeline are connected between the spray gun housing and the power assembly.

The present invention further provides a cleaning device assembly with a plurality of working states.

To achieve the above objectives, the present invention adopts the following technical solution: a cleaning device assembly is provided, including: a spray gun assembly, including a spray gun housing, where a spray gun liquid inlet for a fluid to enter and a spray gun liquid outlet for a fluid to be sprayed are provided in the spray gun housing, and the spray gun housing further includes a handle for holding; a power assembly, where the power assembly and the spray gun assembly are separately disposed, the power assembly includes a main housing, a pump disposed in the main housing, and a motor, and the power assembly further includes a fluid inlet for a fluid to enter and a fluid outlet for a fluid to be sprayed; a connecting path, connected between the spray gun assembly and the power assembly, where the connecting path includes a liquid outlet pipeline connected between the spray gun liquid inlet and the fluid outlet; and a battery pack, supplying energy to the motor; and the cleaning device assembly has a first working state and a second working state, in the first working state, the fluid inlet is directly used as a suction port for a fluid; and in the second working state, the fluid inlet is connected to an external water source by a liquid inlet path, and an opening of the liquid inlet path is used as a suction port for a fluid.

In one of the implementations, the liquid inlet path is configured as a garden hose.

In one of the implementations, the first working state includes at least a floating mode in which the fluid outlet is exposed from an external water source.

In one of the implementations, the cleaning device assembly further includes a float structure for driving the power assembly to float on a water surface, and the float structure is detachably connected to the main housing.

In one of the implementations, in the first working state, the float structure surrounds a periphery of the main housing or the float structure is disposed at a joint between the main housing and the connecting path.

In one of the implementations, the float structure is of a two-half type, including a first half housing and a second half housing that are capable of being closed, and the first half housing and the second half housing are connected in a locking manner.

In one of the implementations, an inner cavity of the float structure is a hollow body, the hollow body includes a lower hollow body close to the fluid inlet and an upper hollow body close to the fluid outlet, and a volume of the lower hollow body is less than a volume of the upper hollow body.

In one of the implementations, the main housing drives the power assembly to be in the floating mode by its own buoyancy.

In one of the implementations, the battery pack is independent of the power assembly, and the battery pack is connected to the spray gun assembly.

In one of the implementations, a ratio of a weight of the power assembly to a total weight of the power assembly and the battery pack is not greater than 50%.

In one of the implementations, the connecting path further includes a power supply line for electrically connecting the battery pack and the motor, and both the power supply line and the liquid outlet pipeline are connected between the spray gun housing and the power assembly.

To achieve the above objectives, the present invention further adopts the following technical solution: a cleaning device assembly is provided, including: a spray gun assembly, including a spray gun housing, where a spray gun liquid inlet for a fluid to enter and a spray gun liquid outlet for the fluid entering from the spray gun liquid inlet to be sprayed are provided in the spray gun housing; a connecting member, configured to transmit an external fluid to the spray gun liquid inlet, where an end of the connecting member is attached to the spray gun assembly; and a battery pack, supplying energy, where the battery pack is attached to the spray gun housing; and the connecting member includes a fluid pressurization path for pressurizing a drawn fluid and a connecting path at least capable of transmitting the pressurized fluid to the spray gun assembly, the fluid pressurization path includes a main housing capable of directly being placed in an external water source, and the main housing includes a fluid inlet for a fluid to be drawn and a fluid outlet in communication with the fluid inlet.

In one of the implementations, the fluid pressurization path is configured as a power assembly capable of outputting a power source, and the power assembly includes a pump for pressurizing a fluid and a motor configured to drive the pump.

### BRIEF DESCRIPTION OF THE DRAWINGS

FIG. 1 is a schematic structural diagram of a cleaning device assembly according to the present invention.

FIG. 2 is a specific three-dimensional structural diagram of a power assembly shown in FIG. 1, where the power assembly is connected to a liquid outlet pipeline.

FIG. 3 is a three-dimensional structural diagram of the power assembly shown in FIG. 2 from another perspective.

FIG. 4 is a schematic structural diagram in which a liquid outlet pipeline and a power supply line are separately disposed according to the present invention.

FIG. 5 is a schematic structural diagram when a spray gun assembly is not provided with a power supply assembly according to the present invention.

FIG. 6 is a schematic structural diagram when a spray gun assembly is connected to a power supply assembly according to the present invention.

FIG. 7 is a partial schematic structural diagram in which a liquid outlet pipeline and a power supply line are integrally disposed according to the present invention.

FIG. 8 is an exploded view of the structure of a water and electricity integrated pipe according to the present invention.

FIG. 9 is a cross-sectional view of a partial structure of a water and electricity integrated pipe according to the present invention.

FIG. 10 is another specific three-dimensional structural diagram of the power assembly shown in FIG. 1.

FIG. 11 is a structural exploded view of the power assembly shown in FIG. 10.

FIG. 12 is a three-dimensional structural diagram in which a float structure is removed from the power assembly shown in FIG. 10 and the power assembly is connected to a liquid inlet pipe.

FIG. 13 is a schematic diagram of a first application scenario of a cleaning device assembly according to the present invention.

FIG. 14 is a schematic diagram of a second application scenario of a cleaning device according to the present invention.

FIG. 15 is a schematic diagram of a third application scenario of a cleaning device according to the present invention.

FIG. 16 is a schematic diagram of a fourth application scenario of a cleaning device according to the present invention.

FIG. 17 is a schematic diagram of a fifth application scenario of a cleaning device according to the present invention.

FIG. 18 is a schematic diagram of a sixth application scenario of a cleaning device according to the present invention.

FIG. 19 is a schematic diagram of a seventh application scenario of a cleaning device according to the present invention.

FIG. 20 is a schematic diagram of an implementation of a power assembly.

FIG. 21 is a schematic diagram of another implementation of a power assembly.

FIG. 22 is a schematic diagram of still another implementation of a power assembly.

FIG. 23 is a schematic diagram of a movement state of a power assembly before and after the power assembly collides with a step during movement under pulling of a connecting path.

FIG. 24 is a schematic diagram of a movement state of a power assembly before and after the power assembly collides with a table leg during movement under pulling of a connecting path.

FIG. 25 is a schematic diagram of an implementation after an upper end of a power assembly collides with an obstacle.

FIG. 26 is a schematic diagram of another implementation after an upper end of a power assembly collides with an obstacle.

FIG. 27 is a three-dimensional structural diagram after a power assembly is combined with a float structure.

FIG. 28 is a disassembly view of the power assembly and the float structure in FIG. 27.

FIG. 29 is a three-dimensional structural diagram of the float structure in FIG. 27.

FIG. 30 is a partial structural diagram after the float structure is cut in a vertical direction in FIG. 29.

FIG. 31 is a schematic diagram of a connecting path drawing a power assembly.

FIG. 32 is a schematic diagram of a connecting path drawing another power assembly.

FIG. 33 is a schematic diagram of a connecting path drawing still another power assembly.

### DETAILED DESCRIPTION

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

It should be noted that when a component is “disposed” on another component, the component may be directly on the other component or an intervening component may be present. When one component is “disposed” on another component, the component may be directly disposed on the other component or an intervening component may be present. When one component is “fixed” to another component, the component may be directly fixed on the other component or an intervening component may be present.

Unless otherwise defined, meanings of all technical and scientific terms used in this specification are the same as that usually understood by a person skilled in the technical field to which the present disclosure belongs. In this specification, terms used in the specification of the present disclosure are merely intended to describe objectives of the specific embodiments, but are not intended to limit the present disclosure. The term “or/and” used in this specification includes any or all combinations of one or more listed items.

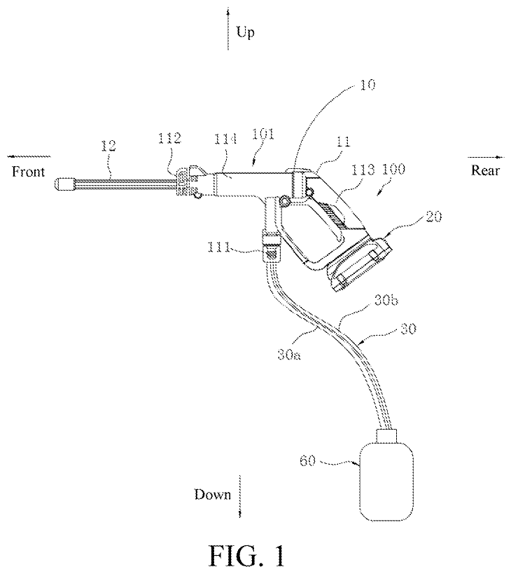

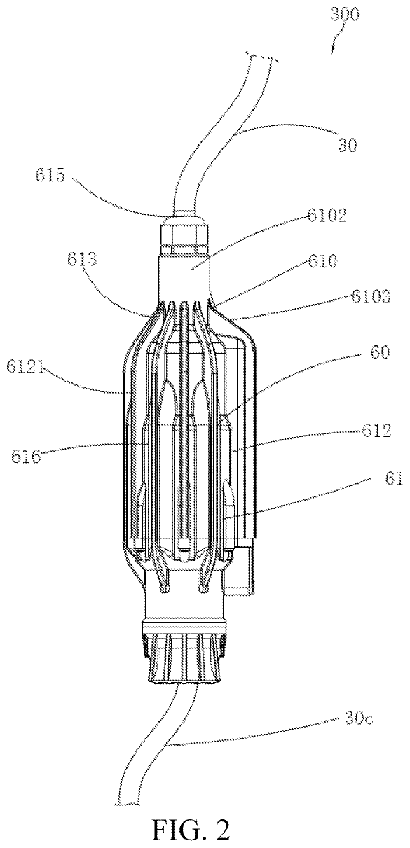

Referring to FIG. 1 and FIG. 2, the present invention provides a cleaning device assembly 100. The cleaning device assembly 100 is configured to pressurize and spray a fluid to assist a user in cleaning a target object. In this implementation, the cleaning device assembly 100 is configured to clean a vehicle by a user. It may be understood that, in another implementation, the cleaning device assembly 100 may further be configured to clean other target objects such as doors and windows, walls, floor glass, courtyard roads, trampolines, and courtyard seats.

The cleaning device assembly 100 includes a spray gun assembly 10, a power supply assembly, and a connecting member 300.

Referring to FIG. 1, the spray gun assembly 10 includes a spray gun housing 11 for holding and a spray bar 12 for spraying a fluid. The spray gun housing 11 is generally pistol-shaped. Certainly, in other embodiments, the spray gun housing 11 may further be in other shapes, for example, a straight bar and a circular bar.

Further, the spray gun housing 11 includes a handle 113 for holding, a main portion 114 disposed at an angle from the handle 113, a spray gun liquid inlet 111 for a fluid to enter, and a spray gun liquid outlet 112 for a fluid to be sprayed. The spray gun liquid outlet 112 is connected to the spray bar 12, so that a fluid entering the spray gun housing 11 is sprayed through the spray bar 12 to the outside. An extending direction of the main portion 114 is basically consistent with a spraying direction of the fluid. The main portion 114 and the handle 113 match each other to form an enclosed space. In this implementation, a fluid that flows through the cleaning device assembly 100 and is used for cleaning an external target object may be water. It may be understood that, in another implementation, the cleaning device assembly 100 may further adopt other types of fluids such as a car shampoo and a cleanser, provided that the fluid is capable of cleaning the external object.

In the present invention, for ease of understanding, referring to FIG. 1, a direction in which water of the spray gun liquid outlet 112 is sprayed is defined as front, a side, away from the spray gun liquid outlet 112, of the handle 113 is defined as rear, the above in the drawings is defined as above, and the below in the drawings is defined as below. The outward in the drawings is defined as a left side, the inward in the drawings is defined as a right side, an extending direction of a motor shaft is defined as an axial direction, a direction that is orthogonal to the motor shaft is defined as a radial direction, a direction that rotates around the motor shaft is referred to as circumferential direction, and a surface that is orthogonal to the extending direction of the motor shaft is defined as an orthogonal surface. The foregoing definitions are only used for description, and should not be understood as a limitation to the present invention.

In this implementation, the power supply assembly may adopt a rechargeable battery pack 20 as a power supply for supplying power. Herein, the battery pack 20 may be a lithium battery pack, a storage battery or the like.

Referring to FIG. 1 and FIG. 2, the connecting member 300 is configured to transmit an external fluid into the spray gun assembly 10 to be sprayed, and the connecting member 300 is attached to the spray gun assembly 10. The connecting member 300 includes a fluid pressurization path for pressurizing a drawn fluid and converting the fluid into a relatively high-pressure liquid flow and a connecting path 30 at least capable of transmitting the pressurized fluid to the spray gun assembly 10. A liquid that flows into the connecting path 30 is sprayed by the spray gun assembly 10 to assist a user in cleaning a target object.

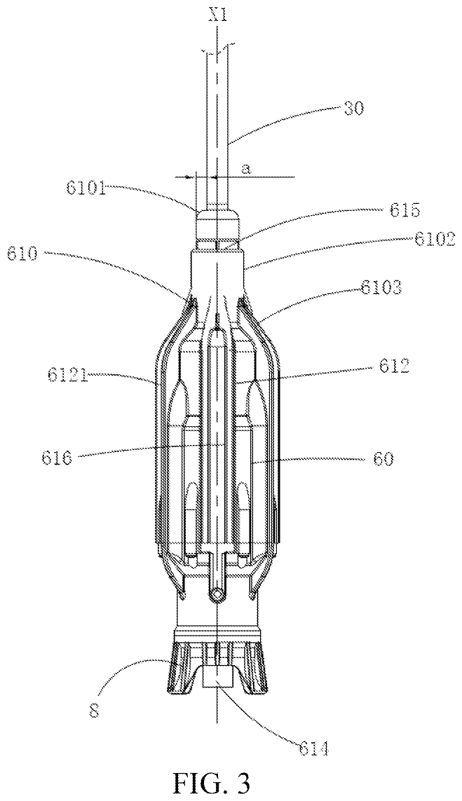

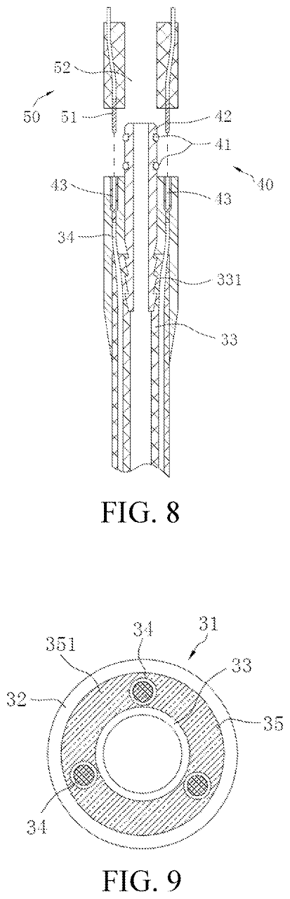

As shown in FIG. 2 and FIG. 3, the fluid pressurization path has a fluid inlet 614 for a fluid to be drawn and a fluid outlet 615 for a fluid to be sprayed. The fluid pressurization path is specifically configured as a power assembly 60 for providing a power source, to pressurize the fluid entering from the fluid inlet 614. Specifically, with reference to the power assembly 60 shown in FIG. 2, FIG. 3, FIG. 8 and FIG. 9, the power assembly 60 includes a main housing 61 and a functional part accommodated in the main housing 61. The functional part includes a motor 62 and a pump 63 driven by the motor 62. The motor 62 is provided with a motor shaft (not shown) for driving the pump 63 to pressurize a fluid, and the motor shaft extends in a vertical direction. The main housing 61 is provided with a joint connected to the connecting path 30 and a support surface 616 that is pulled through the joint and is capable of sliding on the ground. In this implementation, in the cleaning device assembly 100, only the power assembly 60 is provided with the motor 62 and the pump 63, and there is one motor 62 and one pump 63. It should be noted that a difference between the structure shown in FIG. 8 and FIG. 9 and the structure shown in FIG. 2 and FIG. 3 mainly lies in the form of the main housing 61.

As shown in FIG. 1, the connecting path 30 includes a liquid outlet pipeline 30a connected between the fluid outlet 615 and the spray gun liquid inlet 111. The liquid outlet pipeline 30a is configured as a high pressure pipeline capable of withstanding high pressure, and a user may select different lengths according to the user's cleaning requirements.

Further, as shown in FIG. 2, the connecting member 300 further includes a liquid inlet path 30c mated with the fluid inlet 614. In an implementation, the liquid inlet path 30c may be a liquid inlet pipe directly drawing water from an external water source. Preferably, the liquid inlet pipe is a garden hose. In another implementation scenario, the liquid inlet path 30a may also be a container for providing a water source. Preferably, the container is bottle-shaped. Compared with any one of the liquid inlet path 30c and the connecting path 30, the fluid pressurization path has a maximum cross-sectional area in a radial direction. The liquid inlet path 30c and the fluid pressurization path are detachably connected, and the fluid pressurization path and the connecting path 30 may be fixedly connected or may be detachably connected, to facilitate accommodation.

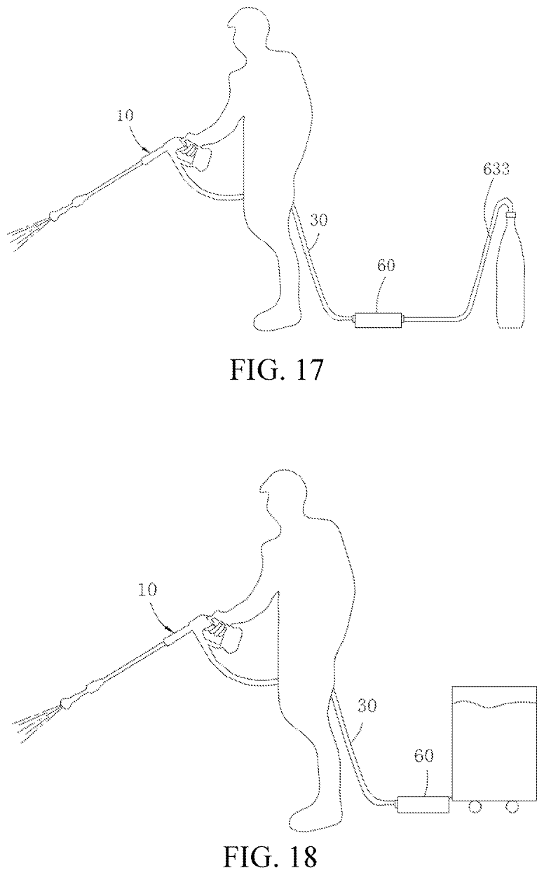

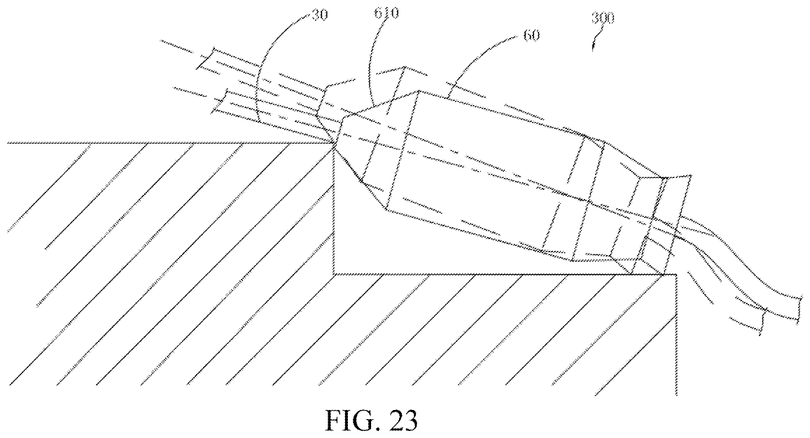

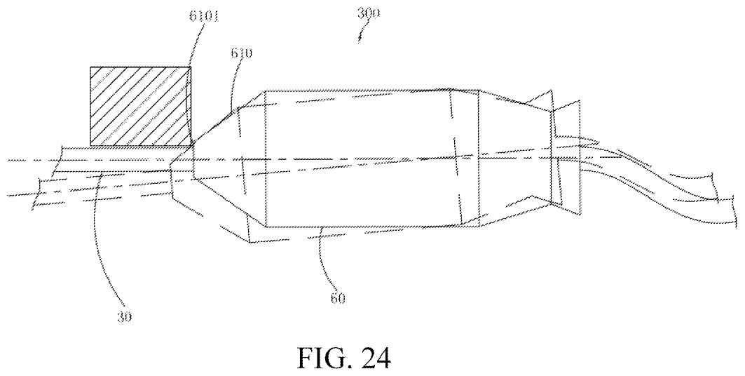

In this implementation, as shown in FIG. 17, FIG. 23, and FIG. 24, the power assembly 60 is allowed to be transversely placed and freely slide on the ground under a pulling force of the connecting path 30 and with direct support by the main housing 61. Herein, the ground may be an outdoor scenario of grass, cement ground, or the like of a home courtyard. There are many obstacles in the ground, for example, pot holes, soil blocks, trampolines, tables and chairs, and steps.

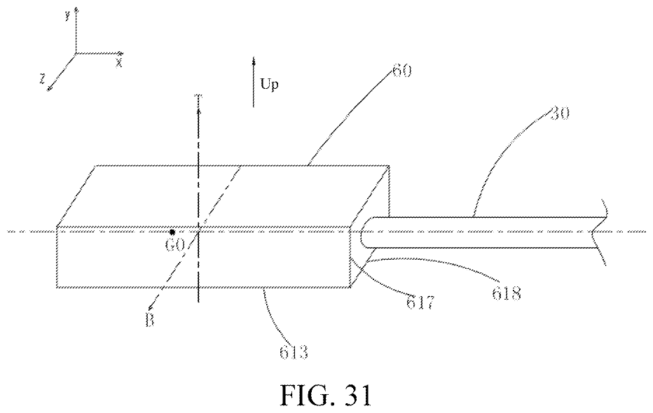

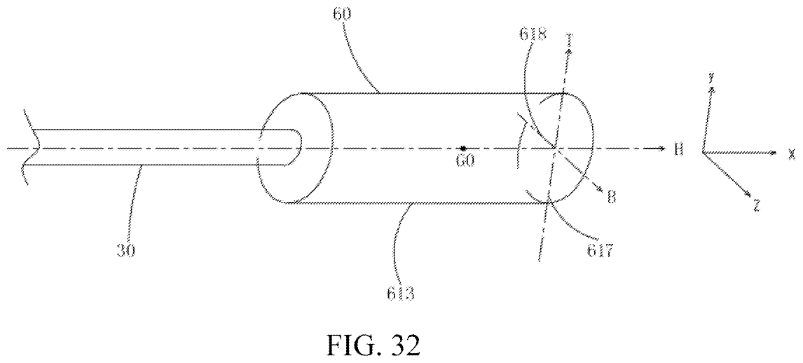

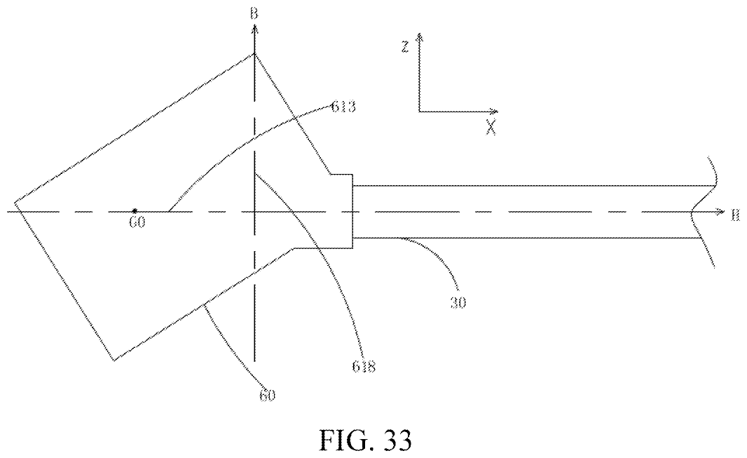

As shown in FIG. 31 to FIG. 33, the main housing 61 extends in three orthogonal spatial directions (x, y, z), that is, a direction of a height axis H of the main housing 61, a direction of a depth axis T of the main housing 61, and a direction of a width axis B of the main housing 61. The main housing 61 has a height 613, a depth 617, and a width 618. In this implementation, the height 613 of the main housing 61 is greater than the width 618 of the main housing, and the height 613 of the main housing is greater than the depth 617 of the main housing. In this application, a pulling direction of the joint is consistent with an extending direction of the height axis H. In this way, when the user holds the spray gun 101 and drives the power assembly 60 to move forward, and the power assembly 60 is not prone to tilting. It should be noted that when the power assembly 60 is cylindrical, the power assembly has the same width and depth. Referring to FIG. 31 to FIG. 33, three feasible solutions are listed in this application. A difference between FIG. 31 and FIG. 32 mainly lies in the shape of the power assembly 60. Specifically, when the power assembly 60 is horizontally placed on the ground, the power assembly 60 is an elongated cube, or the power assembly 60 is cylindrical. The fluid outlet 615 of the power assembly 60 shown in FIG. 33 is provided in a region in which at least two planes intersect. The connecting path 30 connected to the fluid outlet 615 still extends along the height axis H of the power assembly 60. Compared with an implementation solution shown in FIG. 33, the power assembly 60 shown in FIG. 31 and FIG. 32 has a smaller width and can pass more easily through a relatively narrow area. Further, to minimize the tilting of the connecting path 30 when the connecting path pulls the power assembly 60 to move, in this application, as shown in FIG. 31 to FIG. 33, as observed from above, a center of gravity G0 of the power assembly 60 is located on an extension line of an axial line X1 of the connecting path 30 or a distance offset to left or to right from the axial line X1 is within four times an outer diameter of the connecting path 30. It should be noted that “left or to right” here may also be understood as “forward or backward” of a state of the power assembly shown in FIG. 1.

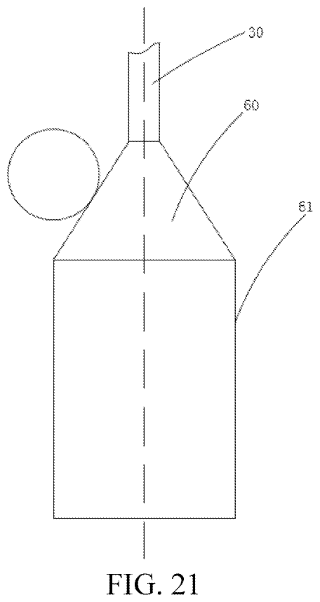

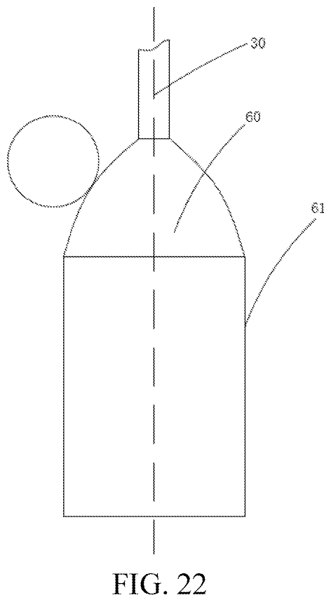

Since the power assembly 60 is easily affected by an obstacle in a moving process, the power assembly is stuck and cannot move. When the connecting path 30 pulls the power assembly 60 to move, the power assembly 60 is suddenly stuck by an obstacle. On one hand, the reliability of a joint between the connecting path 30 and the power assembly 60 is affected. On the other hand, because the connecting path 30 generally has a specific length and the power assembly 60 is away from the user, the user needs to put down the spray gun assembly 10 and returns to a position in which the power assembly is stuck, to manually separate the power assembly 60 from the obstacle or carry the power assembly 60 across the obstacle, affecting human-machine interaction. The power assembly 60 moves forward depending on the pulling of the connecting path 30, it needs to be first ensured that an upper end of the power assembly 60 is not stuck to ensure that the power assembly 60 can smoothly pass the obstacle. As shown in FIG. 23 and FIG. 24, in a process in which the power assembly 60 slides, when the upper end of the power assembly 60 contacts a fixed convex obstacle (for example, a table leg, a chair leg, a support leg of a trampoline or a step), a lower end of the power assembly 60 naturally moves toward the other side away from the obstacle (referring to dotted lines in FIG. 21 and FIG. 22). Therefore, whether the power assembly 60 can smoothly pass the obstacle particularly depends on the structural design of the upper end of the power assembly 60 is.

Because a radial cross-sectional area of the connecting path 30 is small, an end of the connecting path 30 is connected to the upper end of the power assembly 60. As shown in the schematic diagram of FIG. 20, since the upper end of the power assembly 60 has a relatively large end face. The end face and the connecting path 30 directly form an approximately L-shaped bend. The L-shaped bend is prone to collision with an obstacle (for example, a chair leg or a step), further causing the power assembly 60 to be stuck and affecting the free sliding of the power assembly 60 on the ground. It should be noted that a circle in FIG. 18 represents an obstacle.

In this implementation, referring to a specific structural diagram in FIG. 2 and FIG. 3 and a simple schematic diagram in FIG. 21 and FIG. 22, a part of the main housing 61 accommodating the motor 62, the pump 63, and the connecting path 30 is generally in a bottle-shaped structure. The main housing includes a whole body portion 612 surrounding at least a part of an outer side of the functional part and a transition section 610 mated with the connecting path 30, and the transition section narrows from the whole body portion 612 to the connecting path 30. The whole body portion is generally cylindrical. A connection part between the transition section 610 and the whole body portion 612 is in a curved transition connection, to facilitate the sliding of the power assembly 60 across the obstacle. Specifically, as shown in FIG. 21, the transition section 610 may be designed to be pyramidal, and an outer surface of the transition section 610 may be approximately planar. Alternatively, as shown in FIG. 22, the transition section 610 is designed to be approximately a frustum, and an outer surface of the transition section 610 is an outward round chamfer, or certainly may be an inward round chamfer. It should be noted that a circle in FIG. 21 and FIG. 22 represents an obstacle.

More specifically, referring to FIG. 3, the connecting path 30 has an axial line X1 extending in a vertical direction, and a maximum distance a between the axial line X1 and an outermost edge of an upper end face 6101 of the transition section 610 is not greater than five times an outer diameter of the connecting path 30. Further, preferably, the maximum distance between the axial line X1 and the outermost edge of the upper end face of the transition section 610 is not greater than three times the outer diameter of the connecting path. In this way, it may be ensured that the bend built between the upper end face 6101 and the connecting path 30 is small enough or there is no bend there between, so that the obstacle cannot be supported, and the power assembly 60 is not stuck during movement. In this implementation, preferably, the maximum distance a between the axial line X1 and the outermost edge of the upper end face of the transition section 610 is not greater than 60 mm. A ratio of a cross-sectional area of the connecting path 30 in a radial direction to a maximum cross-sectional area of a maximum profile of the upper end face 6101 of the transition section 610 in a radial direction is between 1:1 and 1:70. Preferably, the ratio of the cross-sectional area of the connecting path 30 in the radial direction to the maximum cross-sectional area of the maximum profile of the upper end face 6101 of the transition section 610 in the radial direction is between 1:1 and 1:25. Further, a maximum radial distance between a projection profile of the outermost edge of the upper end face of the transition section 610 on the orthogonal surface and a projection profile of the connecting path on the orthogonal surface is not greater than 55 mm. Preferably, the maximum radial distance between the projection profile of the outermost edge of the upper end face of the transition section 610 on the orthogonal surface and the projection profile of the connecting path on the orthogonal surface is not greater than 30 mm.

It should be noted that the upper end face may be a plane or a curved surface. For a design in which the upper end face is an inclined surface, the cross-sectional area of the upper end face of the transition section in the radial direction should be understood as a circumferential cross-sectional area of a lowest end edge of the inclined surface, and the cross-sectional area should be that of a plane that is orthogonal to an extending direction of the axial line X1.

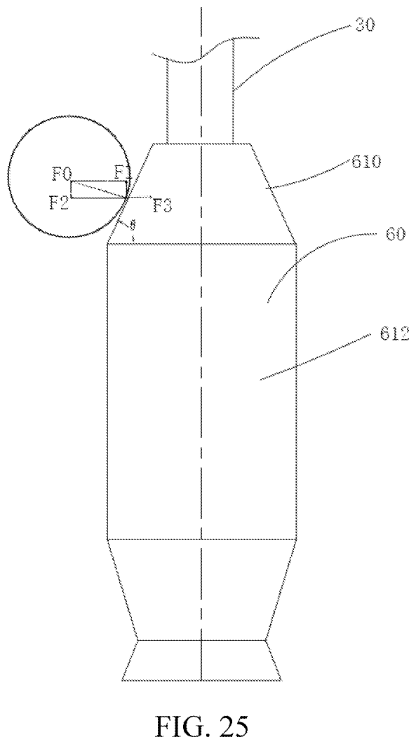

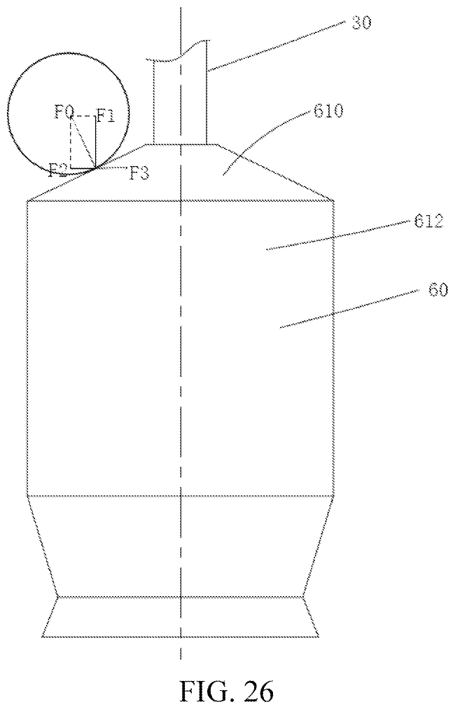

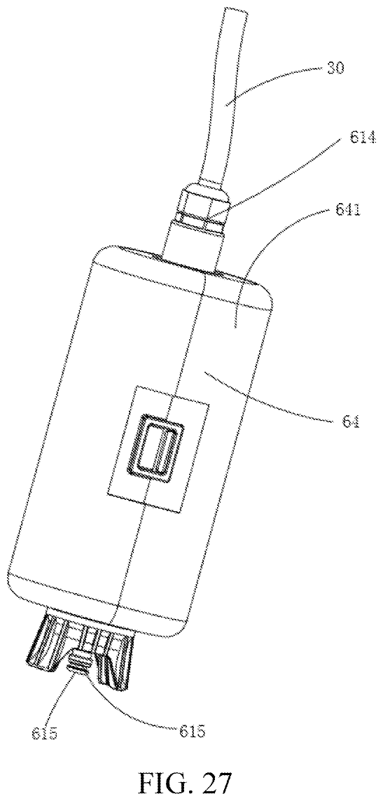

When the power assembly 60 moves, the transition section located on an upper end of the power assembly 60 first contacts the obstacle. Specifically, as shown in FIG. 21 to FIG. 26, when the obstacle (for example, a table leg, a chair leg or a step) strikes the transition section 610, the transition section undergoes an inclined striking force F0 (as shown in FIG. 25 and FIG. 26). The striking force F0 may be decomposed into a forward migration force F1 and a lateral sliding force F2. In this application, the power assembly 60 is horizontally placed on the ground, a support surface 616 of the main housing 61 slides on the ground being supported on the ground, and an area, in contact with the ground, of the power assembly 60 is relatively large. Therefore, a friction force F applied to the power assembly 60 by the ground is relatively large. If an inward component force F3 of the friction force F is greater than F2, in this case, the power assembly 60 is stuck, affecting the free sliding of the power assembly 60.

Referring to FIG. 25 and FIG. 26, a slope of the transition section in FIG. 25 is steeper than that of the transition section 610 in FIG. 26. Therefore, in FIG. 23, a lateral component force F2 of a striking force applied to the transition section 610 is larger, so that when striking a convex obstacle, the power assembly 60 laterally slides away and smoothly moves forward. Specifically, when the power assembly 60 is vertically placed on the ground, as the power assembly 60 is observed from front, an angle θ between an outermost profile line of the transition section 610 and the orthogonal surface is greater than or equal to 30 degrees and less than 90 degrees. Therefore, the acute angle θ may be 35 degrees, 40 degrees, 45 degrees, 50 degrees, 55 degrees, 60 degrees, 70 degrees or the like. Preferably, the angle θ is between 45 degrees and 80 degrees. It should be noted that FIG. 25 and FIG. 26 are merely schematic diagrams. In a specific structural diagram, as shown in FIG. 2 and FIG. 3, there may be a plurality of outer profile lines in the transition section. It should be understood that the outermost profile line of the transition section 610 extends to the front side and forms an angle with the orthogonal surface. Further, the transition section 610 includes a neck portion 6102 extending in a vertical direction and a shoulder portion 6103 connected between the neck portion 6102 and the whole body portion 612, and the fluid outlet 615 is provided at a free end of the neck portion 6102. The shoulder portion 6103 narrows from the whole body portion 612 to the neck portion 6102. Specifically, a cross-sectional area of the shoulder portion 6103 in a radial direction gradually increases from top to bottom.

Preferably, an outer wall surface of the shoulder portion 6103 is of a curved structure. Especially for a cylindrical obstacle, the curved structure is allowed to contact a curved surface of the cylindrical obstacle under the pulling of the connecting path 30, so that the power assembly 60 (the fluid pressurization path) bypasses the obstacle and moves forward. The curved structure may be directly formed by the outer wall surface of the shoulder portion 6103 or may be detachably mounted from the shoulder portion 6103. Specifically, the shoulder portion 6103 is provided with an integral smooth curved surface or may be designed as a plurality of curved convex ribs protruding outward in a radial direction. The curved convex rib may be integrally formed with the shoulder portion 6103 or may be processed subsequently and fixedly disposed on a periphery of the shoulder portion 6103. In addition, the curved structure is not limited, there may be another circular structure.

In an implementation, the curved structure on the shoulder portion 6103 is an inward round chamfer in which a diameter gradually decreases toward an inner side of the power assembly 60. Certainly, in other implementations, the curved structure of the shoulder portion 6103 may also be an outward round chamfer in which a diameter gradually increases in a radial direction. That is, the transition section 610 and the whole body portion 612 of the power assembly 60 are in a curved transition connection. In this way, a diagonally upward force or a force that is basically parallel to the ground is applied to the power assembly 60 through the connecting path 30, so that the power assembly 60 can smoothly slide across a surface of an obstacle by using the curved structure to move freely.

The shoulder portion 6103 may be another structure. Specifically, the shoulder portion 6103 may be a structure detachably connected to an upper end of the whole body portion 612. In addition, in this implementation, as shown in FIG. 2 and FIG. 3, the shoulder portion 6103 and the neck portion 6102 are formed by continuously extending in a direction from the whole body portion 612 to the connecting path 30.

In addition to the convex obstacle (the chair leg or the step), there is also a concave obstacle (a pot hole) in the ground. As the connecting path 30 pulls the power assembly 60 to move, a length of an outer wall surface of the whole body portion 612 in an axial direction is generally greater than a maximum diameter of the pot hole. Therefore, it is easy to slide over the pot holes. In this implementation, a structure of the power assembly 60 is elongated. Specifically, in a direction perpendicular to an extending direction of the motor shaft, a maximum cross-sectional area of the power assembly 60 is not greater than 35,000 mm2. Preferably, in the direction perpendicular to the extending direction of the motor shaft, the maximum cross-sectional area of the power assembly 60 is between 7,000 mm2 and 10,000 mm2. A ratio of a maximum cross-sectional area of the fluid pressurization path (the power assembly 60) in a direction perpendicular to the extending direction of a length of the connecting path 30 to a maximum cross-sectional area of the connecting path 30 in a direction perpendicular to the extending direction of the length of the connecting path is not greater than 445. Preferably, the ratio of the maximum cross-sectional area of the fluid pressurization path (the power assembly 60) in the direction perpendicular to the extending direction of the length of the connecting path 30 to the maximum cross-sectional area of the connecting path 30 in the direction perpendicular to the extending direction of the length of the connecting path is not greater than (90 to 127):1. More specifically, outermost profile lines of projections of the fluid pressurization path and the connecting path 30 on a plane perpendicular to the extending direction of the length of the connecting path (or the extending direction of the motor shaft) are generally circular, so that a user holds the spray gun assembly 10, to pull the connecting member 300 to freely move on the ground. Preferably, at least the whole body portion 612 of the power assembly 60 is generally elongated cylindrical (a cylinder). It should be noted that the circle herein should be understood as that the entire outer profile line may not be perfectly smooth, but may have some inwardly indented curves or some outwardly convex protrusions.

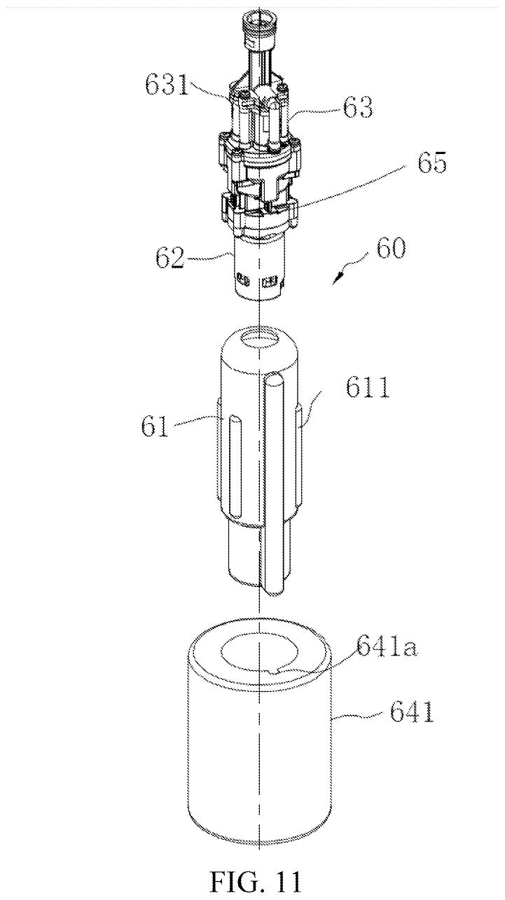

As shown in FIG. 11, the power assembly 60 further includes a transmission mechanism 65 disposed between the motor 62 and the pump 63. The transmission mechanism 65 includes a speed reduction mechanism, and the speed reduction mechanism reduces a rotational speed of the motor 62 and then transmits the speed to the pump 63. The motor 62, the transmission mechanism 65, and the pump 63 are sequentially arranged in an extending direction of the motor shaft. It may further be implemented that the power assembly 60 is placed in a water container with a relatively narrow diameter to absorb water. In addition, in a non-use storage state, a storage occupation area may be reduced, to facilitate storage. Preferably, the speed reduction mechanism is a planetary gear speed reduction mechanism, and the motor 62, the speed reduction mechanism, and the pump 63 are sequentially connected and disposed coaxially.

In this implementation, in consideration of a height of a center of gravity of the power assembly 60 relative to the support surface, the power assembly 60 moves on the ground by using the circumferential support surface 616 of the main housing 61 as a direct support, thereby reducing the difficulty of the power assembly 60 in moving along the ground under the action of the connecting path 30. However, when the power assembly 60 is towed on the ground, the ground is prone to friction or collision with the fluid inlet 614 and the fluid outlet 615, affecting the reliability of a structure of the power assembly 60. Therefore, in this implementation, when the power assembly 60 moves, the fluid outlet 615 and the fluid inlet 614 are in a suspended state. Specifically, as shown in FIG. 3, FIG. 23, and FIG. 24, an opening direction of the fluid inlet 614 and an opening direction of the fluid outlet 615 are opposite to each other and are both axial openings. In a circumferential direction or in a stretching direction of the orthogonal surface, the fluid inlet 614 and the fluid outlet 615 are located in a central region of the power assembly 60. It should be noted that the central region herein should be understood as that outermost profile lines of projections of the fluid inlet 614 and the fluid outlet 615 on the orthogonal surface and an outermost profile line of a projection of the main housing 61 on the orthogonal surface do not overlap, and the outermost profile lines of the projections of the fluid inlet 614 and the fluid outlet 615 are located within a range of the outermost profile line of the projection of the main housing 61. Preferably, an axial line of the fluid inlet 614 is parallel to or basically consistent with (basically collinear with) an axial line of the fluid outlet 615. In an implementation process in which the connecting path 30 pulls the power assembly 60 to slide, the support surface 616 is used as a support, to reduce a contact between the fluid inlet 614, the fluid outlet 615, and the ground. In this implementation, as shown in FIG. 2, a cross-sectional area of the whole body portion on the orthogonal surface is the largest. Therefore, when being horizontally placed on the ground and sliding, the power assembly 60 is capable of moving on the ground by using the whole body portion 612 as a direct support.

Further, as the power assembly 60 moves on the ground, a larger contact area indicates a larger friction force between the power assembly 60 and the ground. Therefore, a pulling force applied to the spray gun assembly 10 by the user is larger, and wear of the ground is increased.

Preferably, the whole body portion 612 further includes a movement structure, and the power assembly 60 is capable of being directly supported by the movement structure and moving under the pulling force of the connecting path 30.

In one of the implementations, referring to FIG. 2 and FIG. 3, the movement structure includes a convex rib 6121 disposed on the whole body portion 612, and there are a plurality of convex ribs 6121 disposed at intervals. The convex rib 6121 extends in an axial direction. Preferably, an outer surface of each convex rib 6121 is a direct smooth curved surface. Certainly, the outer surface of the each convex rib 6121 may be alternatively a plurality of smooth curved protrusions, and the plurality of smooth curved protrusions are disposed radially. The plurality of smooth curved protrusions protrude in a curved shape to the outside in a radial direction, and are intermittently disposed in the circumferential direction of the whole body portion 612. The convex rib 6121 may be the connection protrusion, or may be another protrusion disposed on the whole body portion 612, or may be a protrusion detachably mounted on the whole body portion 612.

When the power assembly 60 is placed on the ground in a manner of using the whole body portion 612 as the support, at least two convex ribs 6121 contact the ground, and the power assembly slides on the ground by using the at least convex ribs 6121 as sliding rails. The two convex ribs 6121 may reduce a tendency of the power assembly 60 to roll in the axial direction, to implement more stable sliding. In addition, a contact area between the power assembly 60 and the ground is reduced. When the power assembly 60 is displaced on a lawn, while wear of the power assembly 60 is reduced, damage to the lawn is further reduced. In addition, when the power assembly 60 is horizontally placed on the ground by using the whole body portion 612 as the support, an arrangement of the convex rib increases a distance between the power assembly 60 and the ground, and a possibility that the fluid inlet 614 and the fluid outlet 615 contact the ground is reduced during movement of the power assembly 60.

Certainly, the movement structure may further be a plurality of support rollers (not shown) disposed at the whole body portion. The power assembly 60 is placed on the ground by using the plurality of support rollers as supports. The plurality of support rollers are capable of rolling on the ground under the action of the pulling force, to implement the movement of the power assembly 60 on the ground. The movement structure is not limited thereto, and may be another structure for reducing a degree of wear of the power assembly 60 and assisting the power assembly 60 in moving.

Different working scenarios have different requirements for a liquid output pressure and a liquid output volume of the cleaning device assembly 100. The liquid output pressure reflects dirt cleaning capability. In a constant liquid output volume, a larger liquid output pressure indicates a larger impact from a liquid on a target object per unit area and a faster removing rate of dirt from a surface of the target object. The required liquid output pressure also changes according to different target objects to be cleaned. The liquid output volume reflects dirt cleaning efficiency. At a constant liquid output pressure, a larger liquid output volume indicates a shorter time of completing the cleaning of the target object. In this implementation, a maximum liquid output pressure externally outputted by the cleaning device assembly 100 may be between 5 Mpa and 13 Mpa, and an externally outputted maximum liquid output volume may be between 250 L/h and 350 L/h, to meet effective cleaning in a middle and heavy working condition scenarios.

To match a relatively high requirement for working performance described above, in this implementation, as shown in FIG. 11, the pump 63 uses a plunger pump 63. In this case, the pump 63 has a better fluid transmission characteristic, and a sprayed liquid flow has better pressure stability. Specifically, the pump 63 is a triple plunger pump, and the triple plunger pump includes a pump body 631, three plungers (not shown) disposed inside the pump body, a liquid inlet end port (not shown) for a fluid to enter, and a liquid outlet end port (not shown) for a fluid to leave. The liquid outlet end port is in communication with the fluid outlet 615, and the liquid inlet end port (not shown) is in fluid communication with the fluid inlet 614. The three plungers reciprocate relative to each other by 120 degrees phase difference. Water is pumped by using the three plungers, the pumping efficiency is much higher. Certainly, the three plunders reciprocate, and sliding resistance between the three plungers and the pump body is relatively large, energy consumption is increased, and a motor with a relatively high rated power is required to overcome the sliding resistance of the three plungers. In this implementation, a rated power of the motor 62 is between 300 W and 1500 W. In this way, to achieve a relatively long battery life of the battery pack 20, a normal cleaning time of the cleaning device assembly 100 is maintained. In an implementation, a large-capacity single pack is selected for the battery pack 20. Specifically, there is one battery pack 20. A nominal output voltage of the battery pack 20 is between 18 V and 80 V, and a capacity of the battery pack 20 is between 2 Ah and 12 Ah, so that a weight of the spray gun 101 equipped with the battery pack 20 is not greater than 2.5 kg to 4.5 kg. In another implementation, there are two battery packs 20. A nominal output voltage of each battery pack 20 is between 18 V and 42.4 V, and a capacity of the each battery pack 20 is between 2 Ah and 8 Ah, so that a weight of the spray gun 101 is not greater than 2.5 kg to 4.5 kg.

In the concept of the present invention, as shown in FIG. 2, the power assembly 60 (the fluid pressurization path) is disposed between the connecting path 30 and the liquid inlet path 30c. The power assembly 60 is configured in a tubular-like form (for example, as described above, at least a part of the main housing 61 may be in a bottle-shaped configuration, and the whole body portion 612 is generally cylindrical). That is, the connecting member 300 may be understood as an entire pipeline, a difference between the connecting member and a general garden hose lies in that an enlarged pipeline (the fluid pressurization path) is connected to a middle end of the connecting member. The entire product form is defined as that a user holds the handle 113 and drives the connecting member 300 attached to the spray gun 101 to freely move by using the spray gun, to implement fast switching between different cleaning scenarios and improve use convenience of the user.

In a common commercially available cleaning device, to reduce the fatigue when the user performs cleaning work for a long time, it is generally avoided to provide any relatively heavy body on the spray gun 101. The spray gun 101 is almost formed by only a spray gun housing 11 that is mated with a main unit casing through the garden hose, thereby minimizing the force with which an operator holds the machine. In this way, the main unit casing is large in size and heavy in weight, which limits mobility of the cleaning device assembly 100. However, the battery pack 20, the motor 62, and the pump 63 are main weight bodies of the cleaning device assembly 100. The main weight bodies are concentrated on the power assembly 60, inevitably limiting agility of movement of the power assembly 60.

To implement that the power assembly 60 is capable of freely moving under the traction of the connecting path 30, In addition to considering a form design of the power assembly 60, position arrangement of a battery pack, a motor, and a pump in an existing product is further changed in this application, to ensure that a weight of the hand-held spray gun is relatively light, and a weight of the power assembly can be reduced, to reduce a dragging force to be applied to the power assembly 60, to facilitate free and quick movement of the power assembly 60 on the ground.

Preferably, the battery pack 20 and the functional part are distributed. Specifically, the battery pack 20 is connected to the spray gun assembly 10 and is used for supplying energy to the cleaning device assembly 100, and the battery pack 20 matches the spray gun assembly 10 to form the spray gun 101. In an implementation, the battery pack 20 is disposed on the handle 113, the spray gun liquid inlet 111 is disposed on the spray gun housing 11 close to the battery pack 20, and the spray gun liquid outlet 112 is disposed on the spray gun housing 11 away from the battery pack 20, so that a fluid flowing out from the spray gun liquid outlet 112 is prevented from being sprayed onto the battery pack 20, to avoid unnecessary safety accidents. In another implementation, in a longitudinal direction, the battery pack 20 is located in the enclosed space. Specifically, the battery pack 20 is located below the main portion 114 and is located in the front of the handle 113, that is, the handle 113 and the battery pack 20 are located on the same side of a central axis of the main portion 114. Through the arrangement, the battery pack 20 does not need to be placed in an additional expanded space, a size of the spray gun assembly 10 in a vertical direction is not increased as much as possible, a size of the spray gun assembly 10 in a transverse direction is not increased, and the structure is compact. Certainly, in other implementations, the battery pack 20 may be alternatively disposed on the power assembly 60. However, to help the user hold the spray gun 101 to drive the power assembly 60 to move, a mounting position of the battery pack 20 should match arrangement of the functional part. Specifically, the battery pack 20, the motor 62, the transmission mechanism 65, and the pump 63 may be sequentially arranged in an extending direction of the motor shaft. In this case, the battery pack 20 may be arranged above the pump 63 or below the motor 62.

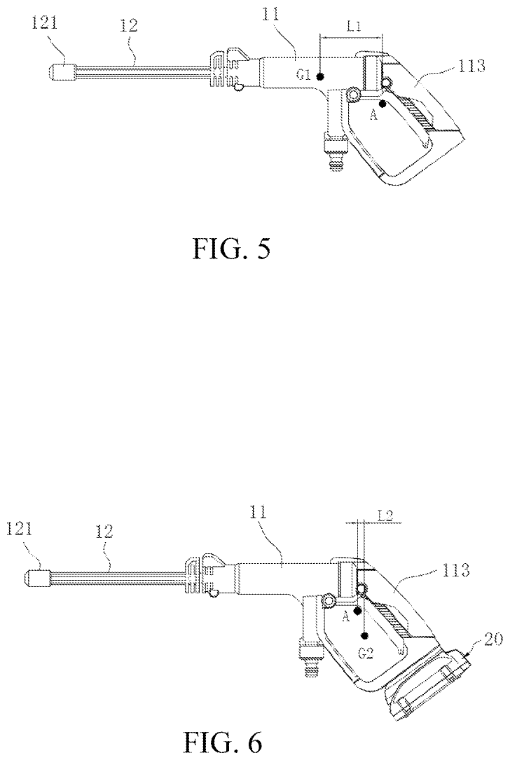

Further, in consideration of a cleaning range of a spray gun, for the spray gun assembly 10 shown in FIG. 5, the spray gun assembly 10 is not connected to a battery pack. The spray gun assembly 10 generally has a spray bar 12 having a specific length, an end of the spray bar 12 is connected to a nozzle 121, and the handle 113 and the spray bar 12 are disposed at an angle. That is, a form of the entire spray gun assembly 10 is that the handle 113 is at the rear, and the spray bar 12 having a specific length is at the front. It is easy to understand that a center of gravity of the spray gun assembly 10 is generally located at a front end of a holding portion of the handle 113 and close to a side of the spray bar 12. For ease of description, it is defined that the nozzle 121 is at a front end, the handle 113 of the spray gun is located at a rear end of the spray gun assembly 10, the center of gravity G1 of the spray gun assembly 10 is generally located at the front end of the holding portion of the handle 113, and a distance between the center of gravity of the spray gun assembly 10 and the holding portion of the handle 113 is relatively large. A distance between the center of gravity G1 of the spray gun assembly 10 and a holding support point of the holding portion of the handle 113 is set to L1. When the user normally holds the spray gun assembly 10 horizontally, that is, when the spray bar 12 of the spray gun assembly 10 is in a horizontal position, because the center of gravity G1 of the spray gun assembly 10 deviates from the holding portion to cause the spray gun assembly 10 to deflect, a lift force for lifting the spray gun assembly 10 is required, and a force for overcoming the deflection is also required. The force to overcome the deflection is used for counteracting a product of the weight of the spray gun assembly 10 and a moment arm L1, that is, is a torque for counteracting the product of the weight of the spray gun assembly 10 and L1. When the moment arm L1 is larger, a deflection force F that needs to be applied multiplies. For this reason, a designer typically reduces the weight of the spray gun assembly 10 while limiting the length of the spray bar 12. Because an excessively long spray bar 12 makes the center of gravity farther away from the handle 113, even if the moment arm L1 is increased, the longer spray bar 12 inevitably increases in weight, resulting in a multiple increase in the force that needs to be applied by the operator to overcome the deflection of the spray gun.

Specifically, as shown in FIG. 5, the handle 113 is not provided with a power supply assembly 20. When an operator holds the handle 113, a holding support point at which the user holds the handle 113 is set to A. When a high pressure fluid enters the spray gun housing 11, the weight of the spray gun assembly 10 is set to m1. In this case, a rotational inertia exerted on the user when the user holds the handle 113 is M1, so M1=m1*g*L1, and g is a gravitational acceleration. It may be understood that a larger rotational inertia M1 indicates a larger force required by the user to overcome the deflection.

It should be noted that the holding support point is specifically a position in which an index finger of a holding hand of the operator presses against the spray gun housing 11 when the operator grips the handle 113 by hand. The holding support point provides an important force-bearing point at which the user's hand supports the spray gun assembly 10 and is also a rotation point at which the spray gun assembly 10 deflects. The holding support point is determined by an arrangement position of the holding portion of the handle 113 and is generally located at an upper end of the holding portion of the handle 113, that is, an end close to a central axis of the spray bar 12.

In this embodiment, referring to FIG. 6, the power supply assembly 20 is connected to the spray gun housing 11. That is, the power supply assembly 20 is connected to the spray gun assembly 10, to form the spray gun 101 with a power supply for the operator to hold. Specifically, the power supply assembly 20 is mounted at an end, away from the spray gun liquid outlet 112, of the handle 113. That is, the power supply assembly 20 is away from the power assembly 60 and is disposed separately from the power assembly 60.

As shown in FIG. 6, the power supply assembly 20 is disposed on the handle 113, and the power supply assembly 20 is mounted at an end, away from a rear end of the spray bar 12, of the handle 113. When a user holds the handle 113, a holding support point at which the user holds the handle 113 is also A. In this case, the arrangement of the power supply assembly 20 causes a general center of gravity G2 of the spray gun 101 to move toward the holding support point A. Compared with the spray gun assembly 10 shown in FIG. 5, the center of gravity G2 of the spray gun 101 shown in FIG. 6 is closer to the holding handle 113. A weight of the entire spray gun formed when the power supply assembly 20 is mounted on the spray gun assembly 10 is m2, a moment arm of the holding support point A of the handle 113 is L2, and a rotational inertia exerted on the operator when the operator holds the handle 113 is M2, so that M2=m2*g*L2, and g is a gravitational acceleration.

However, the power supply assembly 20 is disposed on the spray gun assembly 10, the weight of the spray gun 101 is inevitably increased, and the user needs to overcome a larger gravity when operating the spray gun. During operation of the user holding the spray gun in FIG. 6 (the spray gun assembly in FIG. 5), the force to lift the spray gun 101 or the spray gun assembly 10 is provided by an arm of a human body, that is, the big arm provides the lift force that counteracts gravity, and as the gravity increases, the lift force increases accordingly. The force to overcome deflection is applied by the wrist, and a larger rotational inertia indicates a larger force applied by the wrist to overcome deflection. Tests prove that the spray gun 101 increases a weight of the power supply assembly 20, and a lifting force is applied by the big arm to overcome gravity, so that the user cannot easily feel fatigue. The application of the force to overcome the rotational inertia at the wrist is more likely to cause fatigue, and as a result a user suffers from a sore arm and the working time needs to be kept short.

In this embodiment, a weight of the spray gun formed when the power supply assembly 20 is mounted on the spray gun assembly 10 is m2, only a weight of the power supply assembly 20 is increased, that is, m2−m1 is equal to the weight of the power supply assembly 20. The weight of the power supply assembly 20 is generally between 300 g and 1600 g, and the weight of the spray gun assembly 10 ranges from 300 g to 800 g. Therefore, m2 is generally equal to (2 to 3) times m1. In this embodiment, due to a balancing function of the power supply assembly 20, the center of gravity G2 of the spray gun 101 is close to the holding portion of the handle 113, and that L2 is less than ⅓ of L1 is usually implemented. When L2 is a limit value, that is, when L2=(⅓) L1, because M2=m2*g*L2, M2=(2 to 3) m1*g*(⅓) L1, that is, M2=(⅔ to 1)*m1*g*L1, M2=(⅔ to 1) M1, that is, M2 is less than M1. It may be learned from the foregoing derivation that when the power supply assembly 20 is mounted on the spray gun assembly 10, the weight m2 of the spray gun 101 increases, and the moment arm L2 decreases in a multiple. However, m2*L2 is less than m1*L1, so that the rotational inertia M2 is less than M1. Therefore, in the state shown in FIG. 6, the force that needs to be applied by the operator's wrist to overcome the rotational inertia is reduced. Therefore, the rotational inertia exerted on a user when the user holds the handle 113 is reduced, the holding comfort is improved, and the fatigue in the wrist is reduced. It may be understood that if a distance between the center of gravity G2 of the spray bar 12 in an axial direction and the holding support point A is close to 0, that is, L2=0. In this way, the rotational inertia M2 of the spray gun shown in FIG. 6 is close to 0, the user does not need to apply an extra force to overcome deflection, the wrist is not prone to fatigue, and the operation experience can be greatly improved. In this embodiment, the distance between the center of gravity G2 of the spray gun 101 and the holding support point in the axial direction of the spray bar 12 is less than 5 cm. Preferably, the distance between the center of gravity G2 of the spray gun 101 and the holding support point in the axial direction of the spray bar 12 is less than 3 cm. In the working state, the spray gun 101 is filled with water, and the spray gun liquid inlet 111 is connected to a water pipe filled with water. Therefore, in the working state, the center of gravity G2 displaces toward the spray bar 12. Therefore, in this embodiment, the center of gravity G2 is located on one side of the holding support point close to the power supply assembly 20 to balance the impact of a water pipe and water on the center of gravity of the spray gun 101 in the working state.

As shown in FIG. 1, the power assembly 60 includes a functional part. More specifically, the battery pack 20 is independent of the power assembly 60 and is detachably connected to the spray gun housing 11. The battery pack 20 and the spray gun assembly 10 are assembled to form the spray gun 101 with a power supply for the operator to hold. The spray gun assembly 10 and the power assembly 60 are disposed separately. That is, the main weight body is divided and attached to two different bodies (the spray gun assembly 10 and the power assembly 60) respectively, and the weight of the power assembly 60 and the weight of the spray gun 101 can be balanced while it is ensured that the weight of the spray gun 101 does not increase one-time grip fatigue of an operator. Further, it may be understood that compared with a hand-held integrated cleaning device, the power assembly 60 is disposed outside the spray gun assembly 10. In the case in which the battery pack 20 is similarly configured, the weight of the spray gun assembly 10 is reduced, so that the spray gun assembly 10 is made portable, to provide better human-machine interaction and safer use. Meanwhile, the power assembly 60 is externally provided to the spray gun assembly 10, so that the power assembly 60 can be replaced with the power assemblies 60 of different powers according to the requirements of different use environments to meet the use requirements and improve the cleaning effect. Certainly, in other implementations, the battery pack may be alternatively configured inside the spray gun housing.

In addition, the battery pack is disposed outside the power assembly 60, to reduce the weight of the power assembly 60. When the power assembly slides on the ground, a friction force is small, so that the power assembly 60 can be conveniently dragged by a user and can be easily lifted. In this implementation, a ratio of the weight of the power assembly 60 to a total weight of the spray gun 101 and the power assembly 60 is not greater than 50%. Specifically, the weight of the power assembly 60 is 1.6 kg, and the weight of the spray gun 101 is 2.5 kg. In some extreme scenarios, for example, even if a part of the structure of the power assembly 60 falls into a pot hole, because the power assembly 60 has a relatively light weight, a user may apply an upward force perpendicular to the ground, enabling the power assembly 60 to be separated from the obstacle.

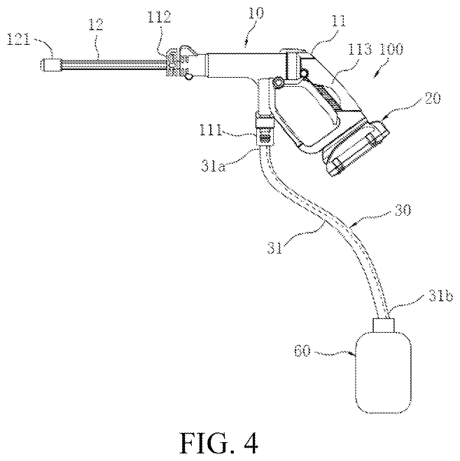

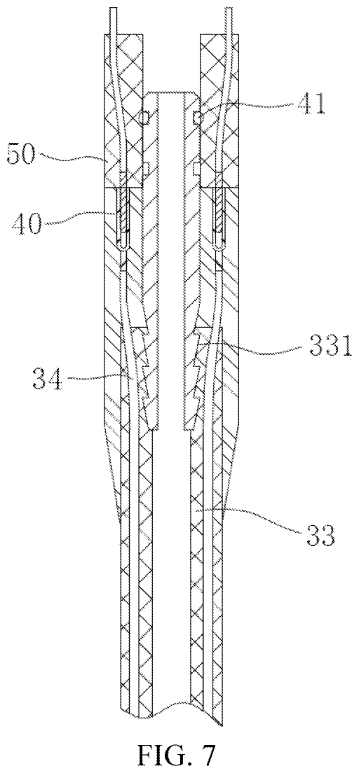

Referring to FIG. 4, FIG. 7, and FIG. 8, the liquid outlet pipeline 30a is connected between the fluid outlet 615 and the spray gun liquid inlet 111 and is used for transporting a fluid from the fluid outlet 615 to the spray gun liquid inlet 111 for replenishing a liquid flow for cleaning the target object. The connecting path 30 further includes a power supply line 30b electrically connecting the battery pack 20 and the motor 62, and the power supply line 30b is also connected between the spray gun housing 11 and the power assembly 60, to implement power supply of the power supply assembly to the power assembly 60 and signal transmission. That is, both the liquid outlet pipeline 30a and the power supply line 30b are connected between the spray gun housing 11 and the power assembly 60. Specifically, one end of the power supply line 30b is connected to the fluid outlet 615, and the other end is connected to the spray gun liquid inlet 111. One end of the liquid outlet pipeline 30a is connected to the fluid outlet 615, and the other end is connected to the spray gun liquid inlet 111. The liquid outlet pipeline 30a and the power supply line 30b are arranged in the same position, to help a user hold the spray gun by hand to pull the power assembly 60 to move together through the pipeline and the line connected between the spray gun 101 and the power assembly 60. Preferably, the spray gun liquid inlet 111 adopts a quick plug interface, so that the connecting path 30 and the spray gun liquid inlet 111 are assembled and disassembled more quickly, and the connecting path 30 is conveniently accommodated. The fluid outlet may also adopt a quick plug interface, so that the connecting path 30 and the fluid outlet are assembled and disassembled more quickly, and the connecting path is conveniently accommodated.

In an embodiment, the liquid outlet pipeline 30a and the power supply line 30b are disposed independently. The liquid outlet pipeline 30a is connected between the spray gun liquid inlet 111 and the fluid outlet 615, to implement connection between the spray gun assembly 10 and the power assembly 60 to transport a fluid pressurized by the power assembly 60 to the spray gun assembly 10. The spray gun assembly is provided with a first electrical connection port, the power assembly 60 is provided with a second electrical connection port, and the power supply line 30b is connected between the first electrical connection port and the second electrical connection port, to electrically connect the power supply assembly 20 and the power assembly 60, so as to implement that the power supply assembly supplies power to the power assembly 60. The liquid outlet pipeline 30a is hermetically connected to the spray gun liquid inlet 111 and the fluid outlet 615, and the power supply line 30b is hermetically connected to the first electrical connection port and the second electrical connection port.

Referring to FIG. 4, in another embodiment, the liquid outlet pipeline 30a and the power supply line 30b are integrally disposed. That is, the liquid outlet pipeline 30a and the power supply line 30b are a water and electricity integrated pipe 31. Through one pipe, both water supply and power supply can be implemented, and signals are transmitted, so that there is a small quantity of connecting bodies (a liquid outlet pipeline and a power supply line) between the spray gun 101 and the power assembly 60, to resolve the problems of complex operations and inconvenient storage when there are many connecting bodies, the connecting bodies are intertwined and a user needs to manually separate lines before the cleaning device assembly 100 works.

Further, referring to FIG. 4, the water and electricity integrated pipe 31 has a first end 31a and a second end 31b that are disposed oppositely. The first end 31a of the water and electricity integrated pipe 31 is hermetically connected to the spray gun liquid inlet 111 and the first electrical connection port, and the second end 31b is hermetically connected to the fluid outlet 615 and the second electrical connection port. The water and electricity integrated pipe 31 implements electrical connection between the power supply assembly and the power assembly 60 and implements communication between the power assembly 60 and the spray gun assembly 10, so that the fluid is pressurized by the power assembly 60, passes through the water and electricity integrated pipe 31, and then enters the spray gun assembly 10 to be sprayed.

Referring to FIG. 4, FIG. 7, FIG. 8, and FIG. 9, further, the first end 31a and the second end 31b of the water and electricity integrated pipe 31 are separately provided with first connection ends 40, the spray gun assembly 10 and the power assembly 60 are separately provided with second connection ends 50, and the first connection ends 40 and/or the second connection ends 50 are provided with sealing members 41. The first connection end 40 is inserted into the second connection end 50, and the first connection end 40 is hermetically connected to the second connection end 50 by using the sealing member 41, to avoid a line safety problem caused by leakage of a fluid flowing through the water and electricity integrated pipe 31.

Specifically, the first connection end 40 includes a water connector 42 and an electrical connection hole 43. The second connection end 50 includes an electrical connector 51 and a water connection hole 52, the water connection hole 52 is in communication with the spray gun liquid inlet 111, and the electrical connector 51 is in communication with the first electrical connection port. The water connector 42 and/or the electrical connector 51 is provided with the sealing member 41. The water connector 42 is inserted into the water connection hole 52, the electrical connector 51 is inserted into the electrical connection hole 43, and the sealing member 41 is hermetically connected to an inner wall of the water connection hole 52, thereby implementing sealing between the water connector 42 and the water connection hole 52 and/or sealing between the electrical connector 51 and the electrical connection hole 43.

It may be understood that the water connector 42 is inserted into the water connection hole 52, to introduce a pressurized fluid into the spray gun assembly 10. The electrical connector 51 is inserted into the electrical connection hole 43, to implement electrical connection between the power assembly 60 and the power supply assembly 20.

It should be understood that, in other embodiments, a position and a structure of the first connection end 40 and a position and a structure of the second connection end 50 may be interchanged. The first connection end 40 and the second connection end 50 with the positions interchanged match each other. Sealing is performed between the first connection end 40 and the second connection end 50 by using the sealing member 41.

Further, the water and electricity integrated pipe 31 includes a pipe body 32, a liquid supply pipe 33 disposed in the pipe body 32, and a power supply line 34 provided between the pipe body 32 and the liquid supply pipe 33. Herein, it may be learned that the liquid supply pipe 33 and the power supply line 34 are integrated, so that the water and electricity integrated pipe 31 has both a function of conveying a fluid and a function of supplying power and transmitting a signal. Further, the spray gun housing 11, the power supply assembly, and the power assembly 60 are prevented from being connected by more water pipes and electric lines, so that the overall structure of the cleaning device assembly 100 is simpler, and it is more convenient to use the cleaning device assembly and maintain pipelines.

The pipe body 32 is made of a tear-resistant, wear-resistant, and bend-resistant polymer material. The polymer material may be thermoplastic polyurethanes (TUP), polyvinyl chloride (PVC) or the like. The liquid supply pipe 33 is used for transporting a fluid. A spacing layer 35 is provided between an inner wall of the pipe body 32 and the liquid supply pipe 33. The power supply line 34 is accommodated in the spacing layer 35. Certainly, in other implementations, the spacing layer 35 may not be provided between the inner wall of the pipe body 32 and the liquid supply pipe 33. In this case, the power supply line 34 may be embedded into a pipe wall of the pipe body 32. Therefore, whether the spacer layer 35 is provided may be determined according to an actual requirement. In this embodiment, the spacing layer 35 is provided between the inner wall of the pipe body 32 and the liquid supply pipe 33.

It may be understood that the structural form of the water and electricity integrated pipe 31 is not limited to the above description. For example, the power supply line 34 may be externally attached to the water and electricity integrated pipe 31 to form an integral body; or the power supply line 34 and the water and electricity integrated pipe 31 may be integrally formed. In this implementation, the power supply line 34 is accommodated in the water and electricity integrated pipe 31, so that the power supply line 34 and the water and electricity integrated pipe 31 are integrally disposed.

An anti-loosening structure 331 is disposed between the liquid supply pipe 33 and the water connector 42, so as to prevent the water connector 42 from loosening when the water and electricity integrated pipe 31 is pulled from and inserted in the spray gun liquid inlet 111. Specifically, the anti-loosening structure 331 includes a sawtooth unit disposed on the water connector 42, and the sawtooth unit is connected to the inner wall of the liquid supply pipe 33.

Further, in this embodiment, the power supply line 34 is accommodated in the spacing layer 35. The power supply line 34 includes a power cable and a signal cable, the power cable is used for electrical connection, and the signal cable is used for signal transmission. Preferably, the signal cable adopts a transmission cable with a shielding function, so that the signal transmission of the signal cable is prevented from interference by the power cable.

Preferably, the spacing layer 35 is filled with a protection structure 351 that is used for wrapping the power supply line 34 and is fixed in the spacing layer 35, and the power supply line 34 is insulated from a fluid entering the water and electricity integrated pipe 31 by the protection structure 351, to prevent the impact of the fluid on the power supply line 34 and avoid the occurrence of electric leakage and the like.

Certainly, in this embodiment, the spacing layer 35 may be partially or fully filled with the protection structure 351, and a specific filling manner may be performed according to an actual requirement. Partial filling may properly reduce a weight of the water and electricity integrated pipe 31, further making the device portable.

Further, the protection structure 351 is an insulation layer filled in the spacing layer 35. The insulation layer is made of a waterproof, anti-aging, and wear-resistant polymer material. The polymer material may be a thermoplastic elastomer (TPE) and the like.

In this implementation, the pipe body 32, the liquid supply pipe 33, the power supply line 34, and the protection structure 351 are processed by an integral molding process, so as to facilitate processing and manufacturing of the water and electricity integrated pipe 31.

The power assembly 60 is capable of standing on the ground with a lower end at the bottom. In an implementation, referring to FIG. 3, the cleaning device assembly 100 further includes a support structure 8 for supporting the power assembly 60 that is placed vertically, and the support structure 8 is located at a lower end of the whole body portion 612 and surrounds a periphery of the fluid inlet 614. When the power assembly 60 is vertically supported on a support surface, there is a gap between a bottommost end of the fluid inlet 614 and the ground. Therefore, on one hand, when the power assembly 60 is placed vertically, direct contact between the fluid inlet 614 and the ground may be avoided. On the other hand, when the working scenario is switched, the power assembly 60 slides on the ground, the support structure may isolate the fluid inlet 614 from the ground, to reduce collision of the fluid inlet 614.

In this embodiment, the pump 63 includes a liquid inlet end port for a fluid to enter and a liquid outlet end port for a fluid to leave, the liquid outlet end port is in communication with the fluid outlet 615, and the liquid inlet end port is in communication with the fluid inlet 614. The power assembly 60 further includes a fluid channel in communication with the fluid inlet 614 and the liquid inlet end port. A fluid enters the fluid channel from the fluid inlet 614, enters the pump 63 from the liquid inlet end port for being pressurized, and flows from the liquid outlet end port to the fluid outlet 615 to be discharged. Preferably, a length of the fluid channel is between 50 mm and 400 mm, for example, 50 mm, 100 mm, 150 mm, 200 mm, 250 mm, 300 mm, 350 mm or 400 mm. It may be understood that, in other implementations, the pump 63 may adopt other types of fluid transportation devices such as a diaphragm pump and a piston pump, provided that the pump is capable of pressurizing the fluid flow.

The power assembly 60 further includes a motor accommodating body disposed at a periphery of the motor 62, only one end of the motor accommodating body is provided with an opening, and the motor accommodating body is sleeved on the motor 62 through the opening. A cooling chamber circumferentially surrounding the periphery of the motor 62 is formed between the motor accommodating body and the inner wall of the whole body portion 612, and the cooling chamber is in communication with the fluid channel. A fluid drawn from the fluid inlet 614 passes through the cooling chamber, and the liquid removes a part of heat generated by the motor 62 during circulation in the cooling chamber, to dissipate heat for the motor 62. Preferably, the motor accommodating body is made of a thermally conductive material, for example, an aluminum material.

Further, in this implementation, the cleaning device assembly 100 has a first working state and a second working state. In the first working state, the fluid inlet 614 is directly used as a suction port for a fluid, and in the second working state, the fluid inlet 614 is connected to an external water source through the liquid inlet path 30c, and an opening of the liquid inlet path 30c is used as a suction port for a fluid. In this case, the power assembly 60 is separated from the fluid without direct contact with the fluid. Specifically, the liquid inlet path 30c is a garden hose. Certainly, the liquid inlet path 30c is not limited to the garden hose, and further includes an adapter connecting the power assembly 60 and the fluid channel, a water container, and the like.

The first working state includes that the power assembly 60 is directly placed into the external water source, to implement immersion of at least the fluid inlet 614 into the external water source. The user may select either the power assembly 60 to work in the first working state or the second working state according to the cleaning requirements. The first working state includes an immersion working mode allowing complete immersion in water and a floating working mode allowing floating on the water surface. When the power assembly 60 is in the immersion working mode, the fluid inlet 614 and the fluid outlet 615 are both located below the water surface. When the power assembly 60 is in the floating working mode, the fluid inlet 614 is located below the water surface, and the fluid outlet 615 is located above the water surface. The immersion working mode may be embodied in two states of sinking to the bottom of the fluid or suspending in the fluid. When the power assembly 60 sinks to the bottom of the fluid, preferably, overall density of the power assembly 60 is greater than density of water, so that buoyancy of the power assembly is less than gravity of the power assembly. When the power assembly 60 is suspended in the fluid, preferably, the overall density of the power assembly 60 is equal to the density of water, so that buoyancy of the power assembly is equal to gravity of the power assembly.

Because the fluid inlet 614 is directly placed in the fluid, a water entry path between an external fluid and a valve core of a water entry one-way valve in the pump body is relatively short. A length of the water entry path may be considered as a length between the fluid inlet 614 and the liquid inlet end port (a path between the liquid inlet end port of the pump and the water entry one-way valve is omitted herein), and preferably, the length between the fluid inlet 614 and the liquid inlet end port is between 50 mm and 400 mm. Because the water entry path through which the fluid with a specific water pressure flows is relatively short, the loss of water pressure in the flowing process is small. Therefore, a pushing force of a drawn fluid to the valve core of the water entry one-way valve in the pump 63 is relatively large, the one-way valve can be quickly pushed open. When the fluid with a pressure flows through the pump body, most of air in the pump body can be quickly emptied, and a self-priming time is reduced. When the power assembly 60 is in the immersion working mode, further, in this implementation, the motor 62 is close to the fluid inlet 614, and the pump 63 is close to the fluid outlet 615. Such a structural design in which the motor 62 is close to the fluid inlet 614 and the pump 63 is close to the fluid outlet 615 enables the center of gravity of the power assembly 60 to be close to the fluid inlet 614, to place the power assembly 60 in the fluid, helping to ensure that the fluid inlet 614 remains underwater. The fluid outlet 615 located above is closer to the operator to facilitate connection of the water pipe and the spray gun by the operator, and the connecting path 30 is shorter. In addition, the motor 62 is submerged in the fluid to facilitate heat dissipation of the motor 62.

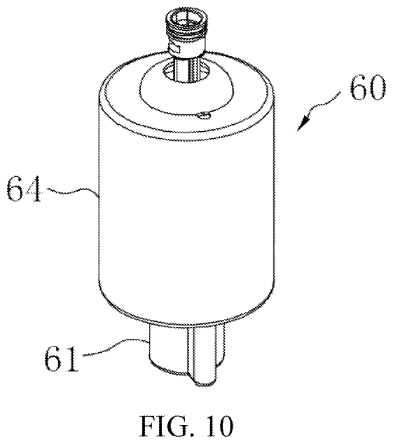

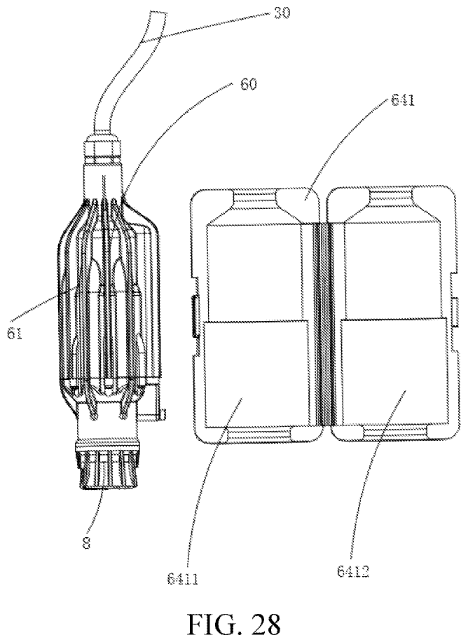

Further, as shown in FIG. 10, FIG. 11, and FIG. 28, the cleaning device assembly 100 further includes a float structure 64. The float structure 64 enables the power assembly 60 to implement a floating working mode. Specifically, in the first working state, a total volume of displacement of the float structure 64 that is deep into an external water source and the power assembly 60 is greater than a total weight of the power assembly, so that at least the fluid outlet 615 is exposed from the external water source.

In addition, alternatively, the overall density of the power assembly 60 may be greater than the density of water, and the power assembly is suspended in the fluid through the float structure 64. The float structure 64 prevents the power assembly 60 from sinking to the bottom of water, prevents the power assembly 60 from interference and damage in an underwater environment, and enables the power assembly 60 to adapt to a turbid or deep water source, for example, a lake, a river, and a pond, so that applicability of the cleaning device assembly 100 is further improved. Specifically, the amount of a float member in the float structure 64 may be increased or reduced. Certainly, in another implementation, other structures may be used for implementation.

As shown in FIG. 28, in this implementation, the float structure 64 includes a float member 641 detachably mounted at a periphery of at least a part of the main housing 61. Therefore, when the float member 641 does not need to be used, the float member 641 may be disassembled from the main housing 61, so that the power assembly moves more flexibly. Certainly, in another implementation, it may be alternatively designed that the float structure 64 is connected to the connecting path 30. Specifically, the float structure 64 is connected to a joint between the main housing 61 and the connecting path 30. The float structure 64 may slide on the connecting path 30. When a user selects the first working state, that is, when the float structure 64 slides to a position close to the power assembly 60, it is ensured that the float structure 64 can drive the power assembly 60 to be in the floating mode, the suspending mode, or the immersion mode.

Referring to FIG. 11, in an implementation, one of the float member 641 and the whole body portion 612 is provided with a connection protrusion 611, the other is provided with a connection groove 641a, and the connection protrusion 611 is slidably mounted in the connection groove 641a, thereby implementing detachable connection between the float member 641 and the power assembly 60. In this embodiment, the connection protrusion 611 is disposed on an outer surface of the whole body portion. The connection groove 641a is located on the float member 641.

Preferably, the float member 641 is cylindrical, the connection groove 641a is provided in an inner wall of the cylinder, and the main housing 61 is sleeved in the float member 641. Certainly, in another implementation, the float member 641 may further be rectangular, spherical or the like. The float member 641 may be a foam plastic ring, an air bag or the like.

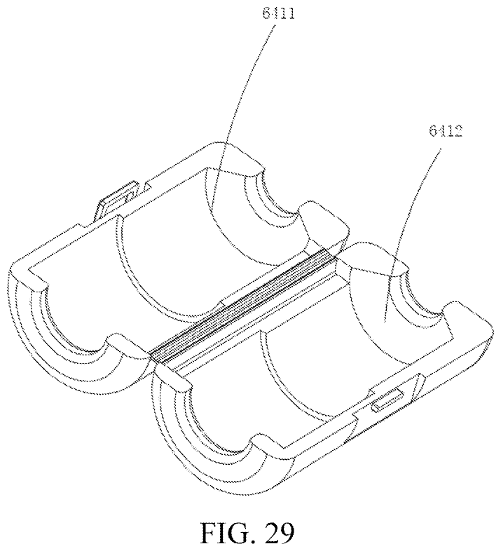

Referring to FIG. 28 and FIG. 29, in another implementation, the float member 641 is of a two-half type, and includes a first half housing 6411 and a second half housing 6412 that are capable of being closed, and the first half housing 6411 and the second half housing 6412 are spliced in a locking manner in a transverse direction.

Certainly, in another implementation, the main housing 61 and the float member 641 may be detachably connected by another structure such as a screw or a bolt.

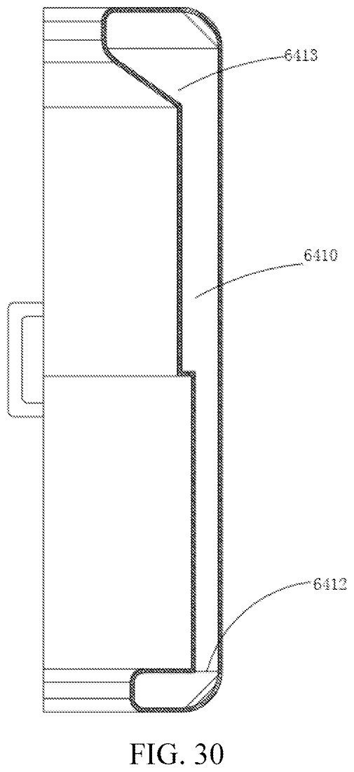

Specifically, as shown in FIG. 30, an inner cavity of the float member 641 is a hollow body 6410, the hollow body 6410 includes a lower hollow body 6413 close to the fluid inlet 615 and an upper hollow body 6412 close to the fluid outlet 614, and a hollow volume of the lower hollow body 6412 is less than a hollow volume of the upper hollow body 6412, to suppress turnover of the power assembly 60 equipped with the float member 641 in the external water source.

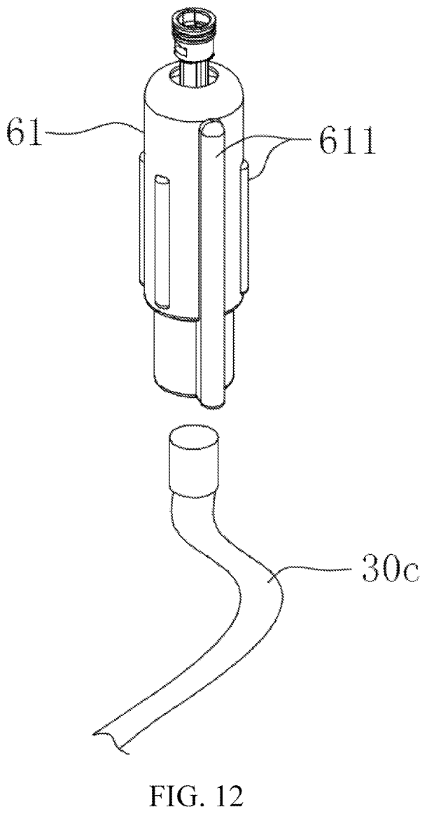

FIG. 12 shows another implementation of the power assembly 60 according to the present invention, and a difference between the implementation and the foregoing implementation only lies in that the power assembly 60 does not include a detachable float structure 64, and the main housing 61 can drive the entire power assembly 60 to be in the first working state by its own buoyancy. Other structures and connection relationships are the same as those in the foregoing implementation, and details are not described again.

In this embodiment, the spray gun assembly 10 is provided with a control mechanism for controlling the motor 62 to operate, and the control mechanism includes a control switch for controlling the motor 62 to be turned on/off and a governor for adjusting a rotational speed of the motor 62. The governor includes at least two speed gears, the control switch is specifically a switch trigger, and the switch trigger is capable of controlling whether to electrically connect or disconnect the power supply assembly 20 and the motor 62.

In this embodiment, the cleaning device assembly 100 further includes a control board (not shown), and the control board is disposed on the spray gun assembly 10. The control board is separately electrically connected to the power supply assembly, the motor 62, and the switch. The control board is internally provided with a control program, and the control program is used for controlling the power supply of the power supply assembly 20, the rotation of the motor 62, and change in the rotational speed of the motor 62. In this embodiment, the control board is disposed above a joint between the handle 113 and the power supply assembly 20. A position of the control board is away from a water outlet of the cleaning device assembly 100, to effectively prevent splashes of water at the water outlet from wetting the control board.

The following describes a cleaning process of the cleaning device assembly 100.

A user holds the handle 113 of the cleaning device assembly 100, connects the external pump 63 and a fluid, and controls, through a control assembly, the motor to drive the pump 63 to work. The fluid pressurized by the pump 63 is transported into the spray gun housing 11 through the connecting member 300 and sprayed from the spray bar 12 to the outside, to clean an external target object.

The cleaning device assembly 100 optionally has a plurality of working states, and the cleaning device assembly 100 can be selectively switched between the working states to adapt to different scenarios, thereby improving the use convenience for the user.

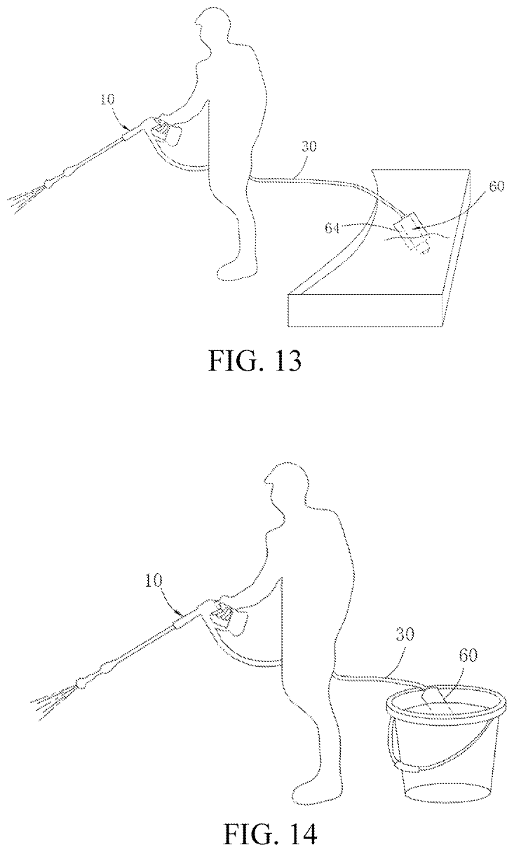

As shown in the embodiments in FIG. 13 and FIG. 14, when the external water source is a clean water source, the power assembly 60 is capable of being placed in the fluid in either state. It is not necessary to consider a case in which the fluid inlet 615 is blocked. As shown in FIG. 13, the external water source is provided by a bucket containing tap water. As shown in FIG. 14, the external water source is a swimming pool or a stream. In a close range cleaning operation (for example, car washing), a user may choose to place the power assembly 60 directly into an external water source for operation.

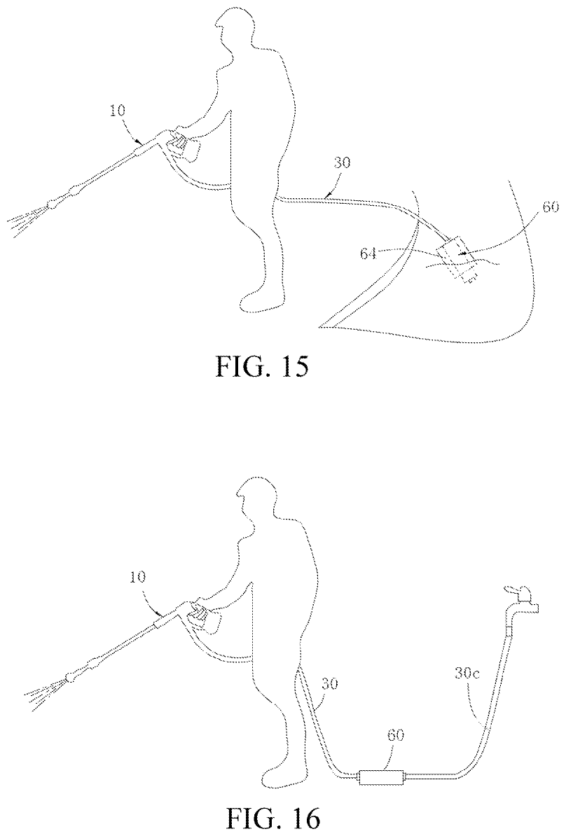

In the embodiment shown in FIG. 15, when the external water source is a non-clean water source, it may be necessary to consider a case in which impurities block the fluid inlet 614 or impurities block a flowing path between the fluid inlet and the liquid inlet end port of the pump 63. As impurities tend to settle in the water source due to gravity, for this scenario, the power assembly 60 may optionally float in the fluid to draw in an upper clean fluid to avoid the impact by impurities in the water source. Fluids are common external waters, for example, lakes, ponds, and rivers, in which large amounts of sediment are often accumulated. The user may select that the power assembly 60 floats in such a fluid and the user can conveniently observe the position of the power assembly 60. In some other embodiments, depending on a depth and cleanliness of the external water source, the power assembly 60 may be alternatively suspended in such a fluid, or the water source may be introduced into the power assembly 60 by connecting a liquid inlet pipe.

In the embodiments shown in FIG. 16 and FIG. 17, the power assembly 60 is in communication with the external water source through a liquid inlet pipe, and the external water source is in communication with the power assembly 60 through a liquid inlet pipe c. As shown in FIG. 16, the external water source is tap water, a garden irrigation water source or the like. Certainly, the liquid inlet pipe may be omitted. The fluid inlet 614 is arranged to be in direct communication with a tap water outlet (a water faucet). Specifically, the fluid inlet 615 may be connected to the water faucet by an adapter. It may be understood that the adapter may be a connecting member that is interconnected, one end is adaptively connected to the water faucet, and the other end is adaptively connected to the fluid inlet 614.

As shown in FIG. 17, the external water source is a liquid contained in a water container. The liquid may be a fluid for a special use, for example, water for a car shampoo. Certainly, the external water source is connected by a liquid inlet pipe, and the external water source may be alternatively swimming pool water, a lake, a river, a pond or the like. The liquid inlet pipe is connected to the fluid inlet 614. Preferably, the fluid inlet 614 is provided with a universal connector for a universal garden water pipe.

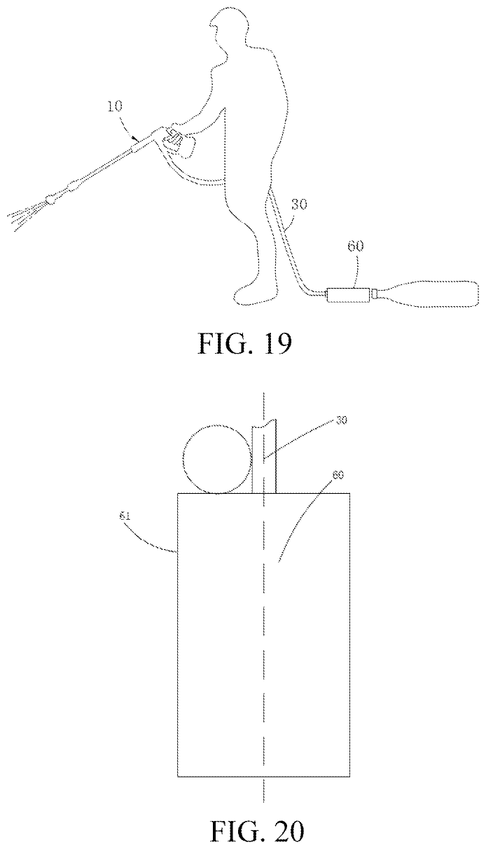

In the embodiments shown in FIG. 18 and FIG. 19, the power assembly 60 is directly mounted with a water container. In the embodiment shown in FIG. 18, the water container is a water tank. In the embodiment shown in FIG. 19, the water container is bottle-shaped, for example, is a cola bottle.

In addition, the cleaning device 100 further has a third working state in which the power assembly 60 is not mounted and a pressurized fluid is directly connected through the liquid inlet pipe. The pressurized fluid should be understood as a fluid that has a specific pressure formed by an external power source, for example, tap water. A water source can be transported to the spray gun assembly 10 through the liquid inlet pipe and sprayed from the spray gun assembly 10 to clean an external target object.

The cleaning device assembly 100 is not limited to only the above first working state, the second working state, and the third working state, but also has other working states suitable for various working environments. Details are not described herein again.

The described embodiments are merely some embodiments of the present invention and are described in detail. However, it should not be understood as a limitation to the patent scope of the present invention. It should be noted that a person of ordinary skill in the art may further be make several variations and improvements without departing from the concept of the present invention, and these variations and improvements all fall within the protection scope of the present invention.

What is claimed is:

1. A cleaning device assembly, comprising:
a spray gun assembly, comprising a spray gun housing, wherein a spray gun liquid inlet for a fluid to enter and a spray gun liquid outlet for a fluid to be sprayed are provided in the spray gun housing, and the spray gun housing further comprises a handle for holding;
a power assembly, wherein the power assembly and the spray gun assembly are separately disposed, the power assembly comprises a pump and a motor configured to drive the pump to work, and the power assembly further comprises a fluid inlet for a fluid to enter and a fluid outlet for a pressurized fluid to be sprayed;
a power supply assembly, supplying energy to the motor; and
a connecting path, connected between the spray gun assembly and the power assembly, wherein the connecting path comprises a liquid outlet pipeline that is connected between the spray gun liquid inlet and the fluid outlet, wherein
the power supply assembly is independent of the power assembly, and the power supply assembly is disposed on the spray gun assembly.

2. The cleaning device assembly according to claim 1, wherein the connecting path further comprises a power supply line for electrically connecting the power supply assembly and the motor, and both the power supply line and the liquid outlet pipeline are connected between the spray gun housing and the power assembly.

3. The cleaning device assembly according to claim 2, wherein the power supply line and the liquid outlet pipeline are configured as a water and electricity integrated pipe, so that both the power supply line and the liquid outlet pipeline are connected between the fluid outlet and the spray gun liquid inlet, to implement both water supply and power supply.

4. The cleaning device assembly according to claim 1, wherein the power supply assembly is a rechargeable battery pack, the battery pack is detachably assembled on the spray gun housing, and the spray gun assembly and the battery pack form a spray gun.

5. The cleaning device assembly according to claim 4, wherein a ratio of a weight of the power assembly to a total weight of the spray gun and the power assembly is not greater than 50%.

6. A cleaning device assembly, comprising:
a spray gun assembly, comprising a spray gun housing, wherein a spray gun liquid inlet for a fluid to enter and a spray gun liquid outlet for a fluid to be sprayed are provided in the spray gun housing;
a battery pack, attached to the spray gun housing; and
a power assembly, disposed separately from the spray gun assembly, and comprising a main housing, a functional part accommodated in the main housing, a fluid inlet for drawing a fluid, and a fluid outlet for discharging the drawn fluid, wherein the functional part comprises a pump for pressurizing the fluid and a motor configured to drive the pump to work, wherein
the cleaning device assembly further comprises a connecting path provided between the spray gun assembly and the power assembly, and the connecting path is at least capable of transmitting a fluid discharged by the fluid outlet to the spray gun liquid inlet; and
the main housing is provided with a joint connected to the connecting path and a support surface that is pulled by the joint and is movable on the ground.

7. The cleaning device assembly according to claim 6, wherein the connecting path has an axial line, and a center of gravity of the power assembly is located on an extension line of the axial line or a distance offset to left or to right from the axial line is within four times an outer diameter of the connecting path.

8. The cleaning device assembly according to claim 6, wherein the main housing comprises a whole body portion surrounding at least a part of an outer side of the functional part and a transition section mated with the connecting path, and the transition section narrows from the whole body portion to the connecting path.

9. The cleaning device assembly according to claim 8, wherein the connecting path has an axial line, and a maximum distance between the axial line of the connecting path and an outermost edge of an upper end face of the transition section is not greater than five times an outer diameter of the connecting path.

10. The cleaning device assembly according to claim 8, wherein a ratio of a cross-sectional area of the connecting path in a radial direction to a cross-sectional area of a maximum profile of an upper end face of the transition section in a radial direction is between 1:1 and 1:70.

11. The cleaning device assembly according to claim 8, wherein the motor comprises a motor shaft, a surface that is orthogonal to an extending direction of the motor shaft is defined as an orthogonal surface, and an angle between an outermost profile line of the transition section and the orthogonal surface is greater than or equal to 30 degrees and less than 90 degrees.

12. The cleaning device assembly according to claim 8, wherein when the power assembly is horizontally placed on the ground, both the fluid inlet and the fluid outlet are suspended and move on the ground by using the whole body portion as a support.

13. The cleaning device assembly according to claim 8, wherein the whole body portion is further provided with a movement structure, the movement structure comprises at least two convex ribs protruding outward, the convex rib extends by a preset length in a vertical direction, and the power assembly is movable by using the convex rib as a sliding rail.

14. The cleaning device assembly according to claim 6, wherein the power assembly further comprises a transmission mechanism disposed between the motor and the pump, the transmission mechanism comprises a speed reduction mechanism for reducing a rotational speed of the motor and transmitting the reduced rotational speed to the pump, and the motor, the transmission mechanism, and the pump are sequentially arranged in an extending direction of a motor shaft.

15. The cleaning device assembly according to claim 6, wherein the connecting path comprises a liquid outlet pipeline connected between the fluid outlet and the spray gun liquid inlet and a power supply line for electrically connecting the battery pack and the motor, the liquid outlet pipeline is capable of transmitting a fluid pressurized by the pump to the spray gun assembly, and both the power supply line and the liquid outlet pipeline are connected between the spray gun housing and the power assembly.

16. A cleaning device assembly, comprising:
a spray gun assembly, comprising a spray gun housing, wherein a spray gun liquid inlet for a fluid to enter and a spray gun liquid outlet for the fluid entering from the spray gun liquid inlet to be sprayed are provided in the spray gun housing;
a power supply assembly, supplying energy;
a connecting member, wherein an end of the connecting member is attached to the spray gun assembly, the connecting member comprises a fluid pressurization path for pressurizing a drawn fluid and a connecting path at least capable of transmitting the pressurized fluid to the spray gun liquid inlet, the fluid pressurization path is configured as a power assembly for providing a power source, the power assembly comprises a main housing, a pump accommodated in the main housing, and a motor configured to drive the pump to work, and the connecting path is disposed between the spray gun assembly and power assembly, wherein
the main housing is provided with a joint that is connected to the connecting path and is capable of pulling the power assembly to move, the main housing extends in three orthogonal spatial directions (x, y, z), that is, in a direction of a height axis of the main housing, a direction of a width axis of the main housing, and a direction of a depth axis of the main housing, the main housing has a height, a width, and a depth, the height is greater than the width, the height is greater than the depth, and a pulling direction of the joint is consistent with an extending direction of the height axis.

17. The cleaning device assembly according to claim 16, wherein the connecting path has an axial line, and a center of gravity of the power assembly is located on an extension line of the axial line or a distance offset to left or to right from the axial line is within four times an outer diameter of the connecting path.

18. The cleaning device assembly according to claim 16, wherein a maximum cross-sectional area of the connecting member is formed on the fluid pressurization path in a direction perpendicular to an extending direction of a length of the connecting path, and the maximum cross-sectional area is not greater than 35,000 mm2.

19. The cleaning device assembly according to claim 16, wherein the connecting member further comprises a liquid inlet path mated with the fluid inlet, and the liquid inlet path is capable of being configured as a liquid inlet pipe for directly drawing an external water source or a container for providing a water source.

20. The cleaning device assembly according to claim 16, wherein the power supply assembly is a rechargeable battery pack, the battery pack is detachably assembled on the spray gun housing, and the battery pack and the power assembly are disposed independently.
